(19) United States
(12) Patent Application Publication
(10) Pub. No.: US 2018/0158156 A1
(43) Pub. Date: Jun. 7, 2018

(54) Property Assessments Using Augmented Reality User Devices

(71) Applicant: BANK OF AMERICA CORPORATION, CHARLOTTE, NC (US)

(72) Inventor: Katherine Dintenfass, Lincoln, RI (US)

(21) Appl. No.: 15/367,435

(22) Filed: Dec. 2, 2016

(51) Int. Cl. G06Q 50/16; G06Q 30/02; G06K 9/00; G06T 11/60

(52) U.S. Cl. CPC G06Q 50/16; G06Q 30/0278; G06F 21/32; G06T 11/60; G06K 9/00671

(57) ABSTRACT

An augmented reality system that includes an augmented reality user device. The augmented reality user device includes display for overlaying virtual objects onto tangible objects in a real scene, a camera, and a global position system sensor. The augmented reality user device includes a processor implementing an object recognition engine, a virtual assessment engine, and a virtual overlay engine. The object recognition engine identifies features of a property from an image. The virtual assessment engine authenticates the user, identifies a user identifier for the user, and identifies the property based on the geographic location of the user. The virtual assessment engine captures an image and performs object recognition on the image to identify features of the property. The virtual assessment engine sends a property token to a remote server, receives information related to the property from the server, and presents the information as virtual objects overlaid with the real scene.

### TECHNICAL FIELD

The present disclosure relates generally to performing operations using an augmented reality display device that overlays graphic objects with objects in a real scene.

### BACKGROUND

When a person is evaluating a real estate property, for example, as an investment or for renovations, the person may need to access information from multiple sources in order to analyze the property and to make various decisions about the property. Existing two-dimensional graphical user interfaces limit the amount of information the person can see based on the size of the display. In addition, the person may have to interact with multiple windows or screens on the graphical user interface in order to view all of the information the person is interested in. Using existing graphical user interfaces and having to interact with multiple windows or screens causes a disconnect between the information being present and a real world environment.

Using existing systems, when a person is looking for information that is located among different databases with different sources, the person has to make data requests to each of the different sources in order to obtain the desired information. The process of making multiple data requests to different data sources requires a significant amount of processing resources to generate the data requests. Typically, processing resources are limited and the system is unable to perform other tasks when processing resources are occupied which degrades the performance of the system.

The process of sending multiple data requests and receiving information from multiple sources occupies network resources until all of the information has been collected. This process poses a burden on the network which degrades the performance of the network. Thus, it is desirable to provide the ability to securely and efficiently aggregate information from multiple data sources.

### SUMMARY

In one embodiment, the disclosure includes an augmented reality system with an augmented reality user device for a user. The augmented reality user device has a display for overlaying virtual objects onto tangible objects in a real scene in real-time. The augmented reality user device also has a camera configured to capture images of tangible objects and a global position system (GPS) sensor that provides the geographic location of the user. The augmented reality user device further includes one or more processors operably coupled to the display, the camera, and the GPS sensor.

The processors implement an object recognition engine, a virtual assessment engine, and a virtual overlay engine. The object recognition engine is used to identify tangible objects. The virtual assessment engine authenticates the user based on a user input and identifies a user identifier for the user in response to authenticating the user. The virtual assessment engine generates a location identifier identifying the location of a property based on the geographic location of the user. The virtual assessment engine captures an image of the property and performs object recognition on the image to identify features of the property. The virtual assessment engine generates a property profile based on the identified features of the property. The virtual assessment engine then generates a property token that includes the user identifier, the location identifier, and the property profile. The virtual assessment engine sends the property token to a remote server and receives virtual assessment data in response to sending the property token. The virtual assessment data includes historical property information for the property and a comparable property value. The virtual overlay engine presents the virtual assessment data as a virtual object overlaid with the real scene.

The augmented reality system further includes the remote server that includes a real estate compiler engine. The real estate compiler engine receives the property token and identifies account information for the user based on the user identifier. The real estate compiler engine also identifies the historical property information based on the location identifier and identifies a comparable property based on the property profile. The real estate compiler engine determines the comparable property value for the comparable property. The real estate compiler engine generates virtual assessment data that includes the historical property information and the comparable property value and sends the virtual assessment data to the augmented reality user device.

In one embodiment, an augmented reality user device aggregates information for a user looking at a real estate property. The augmented reality user device identifies the property and features of the property that the user is looking at. The augmented reality user device generates a property profile for the property based on the property and its features. The augmented reality user device aggregates information for the user about the property based property profile. The augmented reality user device presents the information about the property to the user as virtual objects overlaid with the real scene in front of the user. The aggregated information may include information about nearby amenities, information about damage to the property, pricing information, tax information, insurance claims information, liens on the property, historical information about the property, public records, comparable property information, or any other kinds of information.

In another embodiment, an augmented reality user device aggregates geolocation information about a real estate property and its surrounding area. The geolocation information may include places of interest, traffic information (e.g. historical traffic information), commute time information, crime information, or any other kinds of information about the property and/or its surround area. The augmented reality user device provides the aggregated geolocation information to the user as virtual objects overlaid with the real scene in front of the user. In one embodiment, the augmented reality user device provides the aggregated geolocation information to the user as a two-dimension or three-dimensional map.

In yet another embodiment, an augmented reality user device aggregates information for a user looking at features of a house for a project (e.g. a renovation project). The augmented reality user device identifies features of the property and allows the user to overlay virtual objects of alternative features into the real scene in front of the user. The augmented reality user device is able to allow the user to visualize different project end results while aggregating information related to the project. The augmented reality user device also allows the user to aggregate other information for a particular project such as alternative features.

The present embodiment presents several technical advantages. In one embodiment, an augmented reality user device allows a user to reduce the number of requests used to obtain information from multiple data sources. Additionally, the augmented reality user device allows the user to authenticate themselves which allows the user to request and obtain information that is specific to the user without having to provide different credentials to authenticate the user with each data source.

The amount of processing resources used for the reduced number of data requests is significantly less than the amount of processing resources used by existing systems. The overall performance of the system is improved as a result of consuming less processing resources. Recusing the number of data requests also reduces the amount of data traffic required to obtain information from multiple sources which results in improved network utilization and network performance.

The augmented reality user device generates tokens based on the identify of a user and the location of the user which improves the performance of the augmented reality user device by reducing the amount of information used to make a data request. Tokens are encoded or encrypted to obfuscate and mask information being communicated across a network. Masking the information being communicated protects users and their information in the event of unauthorized access to the network and/or data occurs.

The augmented reality user device uses object recognition and optical character recognition to identify the location of the user and/or objects the user is looking at. Retrieving information about the location of the user and objects the user is looking at using object recognition and optical character recognition allows the augmented reality user device to reduce the amount of time required to make a data request compared to existing systems that rely on the user to manually enter all of the information for a request. This process for collecting information for the data request also reduces the likelihood of user input errors and improves the reliability of the system.

Another technical advantage is the augmented reality user device allows a user to view information as a virtual or graphic object overlaid onto the real scene in front of the user. This allows the user to quickly view information in the context of the real scene in front of the user.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an augmented reality system configured to overlay virtual objects with a real scene;

FIG. 2 is a schematic diagram of an embodiment of an augmented reality user device employed by the augmented reality system;

FIG. 3 is an embodiment of a first person view form a display of an augmented reality user device overlaying virtual objects with a real scene;

FIG. 4 is a flowchart of an embodiment of an augmented reality overlaying method for an augmented reality user device;

FIG. 5 is a flowchart of an embodiment of an augmented reality overlaying method for a server;

FIG. 6 is another embodiment of a first person view from a display of an augmented reality user device overlaying virtual objects with a real scene;

FIG. 7 is a flowchart of an embodiment of an augmented reality overlaying method for an augmented reality user device;

FIG. 8 is a flowchart of another embodiment of an augmented reality overlaying method for a server;

FIG. 9 is another embodiment of a first person view from a display of an augmented reality user device overlaying virtual objects with a real scene;

FIG. 10 is a flowchart of another embodiment of an augmented reality overlaying method for an augmented reality user device; and

FIG. 11 is a flowchart of another embodiment of an augmented reality overlaying method for a server.

### DETAILED DESCRIPTION

When a person is evaluating a real estate property as an investment or for renovations, the person may need to access information from multiple sources in order to analyze the property and to make various decisions about the property. For example, the person may want to look up their personal information, information about a real estate property, information about the area surrounding a property, information about a real estate property project, or any other information. All of this information may be located in different databases with different sources which results in several technical problems.

Using existing systems, the person has to make individual data requests to each of the different sources in order to obtain the desired information. The process involves making numerous data requests to different data sources which uses a significant amount of processing resources to generate the data requests. Typically processing resources are limited and the system is unable to perform other tasks when processing resources are occupied which degrades the performance of the system. The process of sending numerous data requests and receiving information from multiple sources occupies network resources until all of the information has been collected. This process poses a burden on the network which degrades the performance of the network.

Additionally, each data request may use different credentials to authenticate the person with each of the different sources. Providing different credentials to each source increases the complexity of the system and increases the amount of data that is sent across the network. The increased complexity of the system makes existing systems difficult to manage. The additional data that is sent across the network both occupies additional network resources and exposes additional sensitive information to network.

A technical solution to these technical problems is an augmented reality user device that allows a user to reduce the number of data requests used to obtain information from multiple sources. The augmented reality user device allows the user to process an image to extract information from for the data request. The augmented reality user device allows the user to authenticate themselves to obtain information that allows the user to request and obtain personal information that is specific to the user with the same data request. The number of processing resources used to generate the reduced number of data requests is significantly less than the number of processing resources used by existing systems to generate the numerous data requests. The overall performance of the system is improved as a result of consuming less processing resources. Using a reduced number of data requests to obtain information from multiple sources reduces the amount of data traffic used to obtain the information which results in improved network utilization and network performance.

Securely transferring data and information across a network poses several technical challenges. Networks are susceptible to attacks by unauthorized users trying to gain access to sensitive information being communicated across the network. Unauthorized access to a network may compromise the security of the data and information being communicated across the network.

One technical solution for improving network security is an augmented reality user device that generates and uses tokens that are used by an augmented reality user device to request potentially sensitive information. The augmented reality user device allows tokens to be generated automatically upon identifying and extracting information from an image. The token may be encoded or encrypted to obfuscate the information being communicated by it. Using tokens to mask information that is communicated across the network protects users and their information in the event of unauthorized access to the network and/or data occurs. The tokens also allow for data transfers to be executed using less information than other existing systems, and thereby reduces the amount of data that is communicated across the network. Reducing the amount of data that is communicated across the network improves the performance of the network by reducing the amount of time network resource are occupied.

The augmented reality user device uses object recognition and optical character recognition of images to quickly retrieve information for generating tokens. The augmented reality user device allows information for generating tokens to be retrieved based on an image of an object which significantly reduces the amount of time required to make a data request compared to existing systems that rely on the user to manually enter all of the information for the request. Using object recognition and optical character recognition to identify and retrieve information also allows the augmented reality user device to be less dependent on user input, which reduces the likelihood of user input errors and improves reliability of the system.

Another technical challenge of using existing systems is the usage of two-dimensional graphical user interfaces. Existing two-dimensional graphical user interfaces limit the amount of information the person can see based on the size of the display. In addition, the person may have to interact with multiple windows or screens on the graphical user interface in order to view all of the information the person is interested in. Using existing graphical user interfaces and having to interact with multiple windows or screens causes a disconnect between the information being present and a real world environment.

An augmented reality user device allows a user view information as virtual or graphical object overlaid onto the physical object in real-time. For example, using the augmented reality user device, the user is able to quickly view information for multiple objects that are in front of the user. The user is able to view information about the object, their personal information, the location of the user, and/or any other information as virtual objects overlaid onto any tangible objects in the real scene in front of the user.

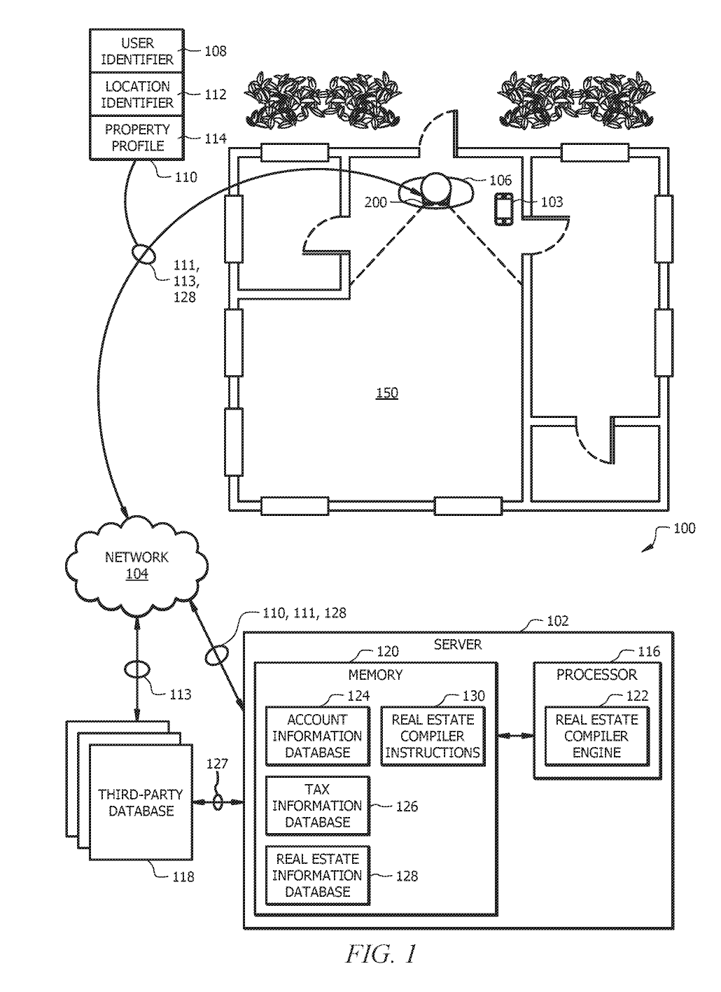

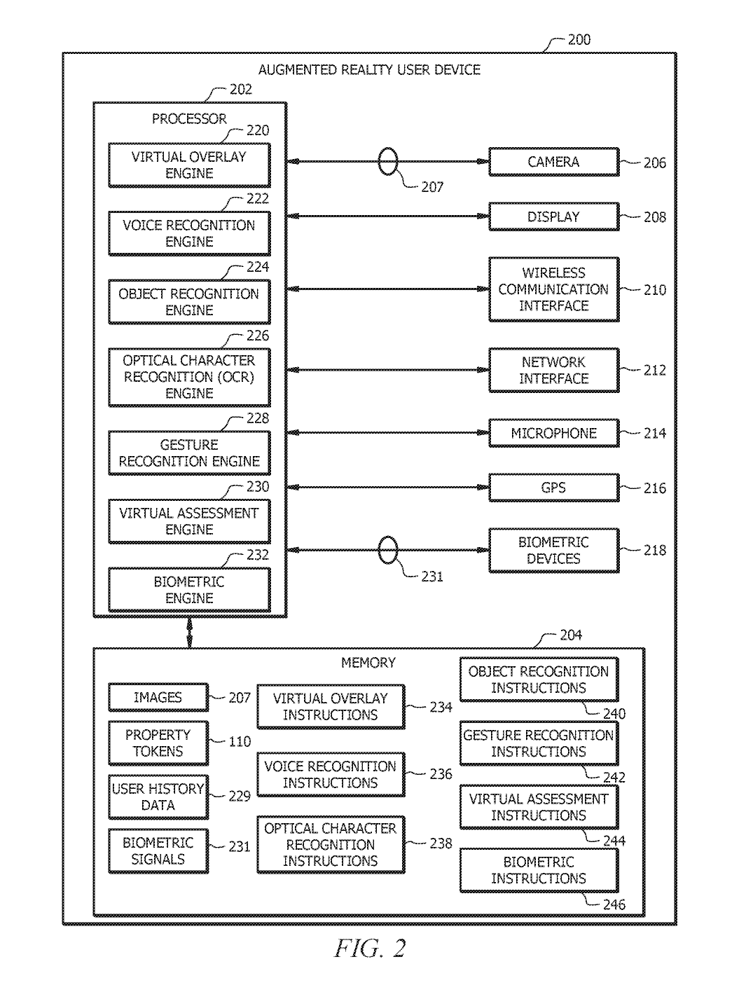

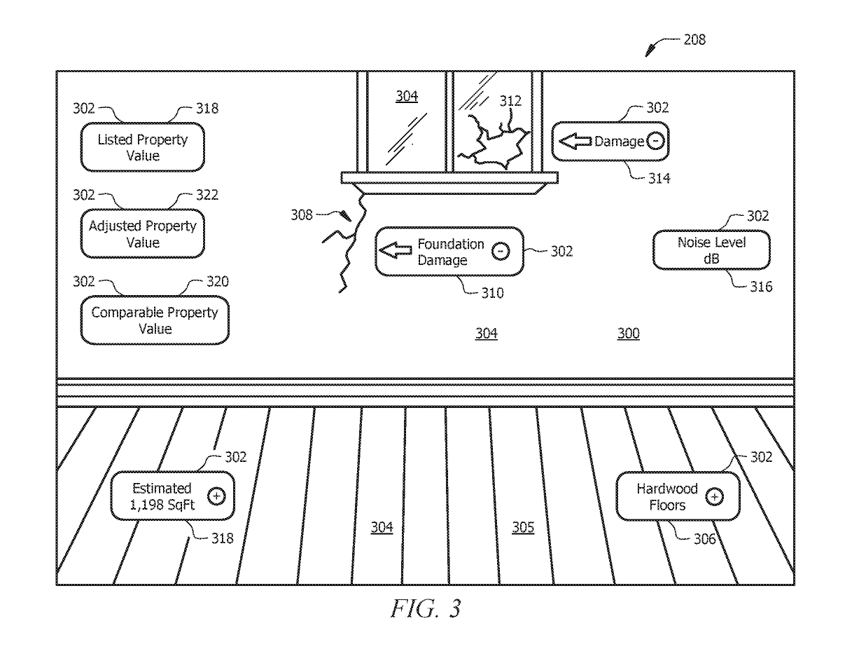

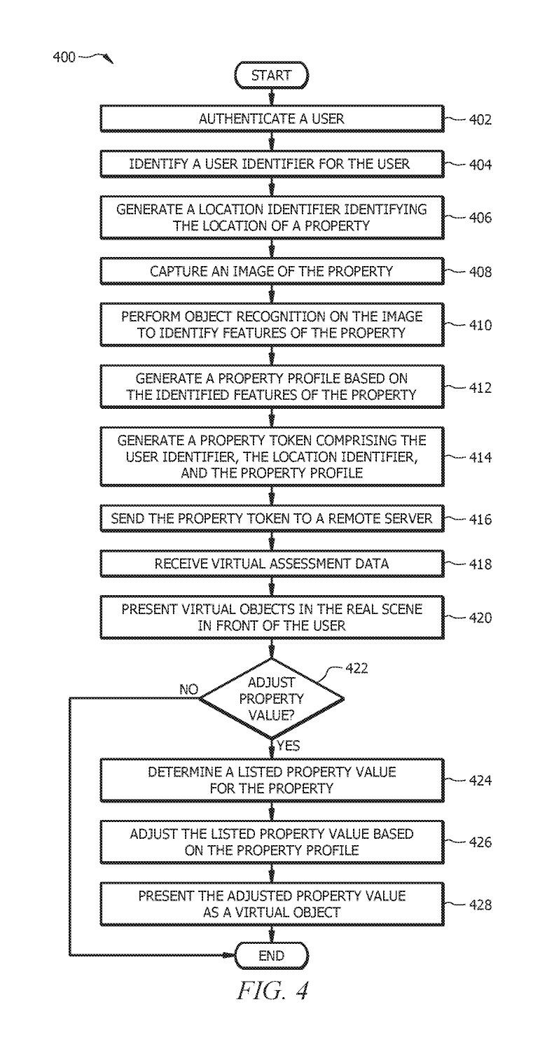

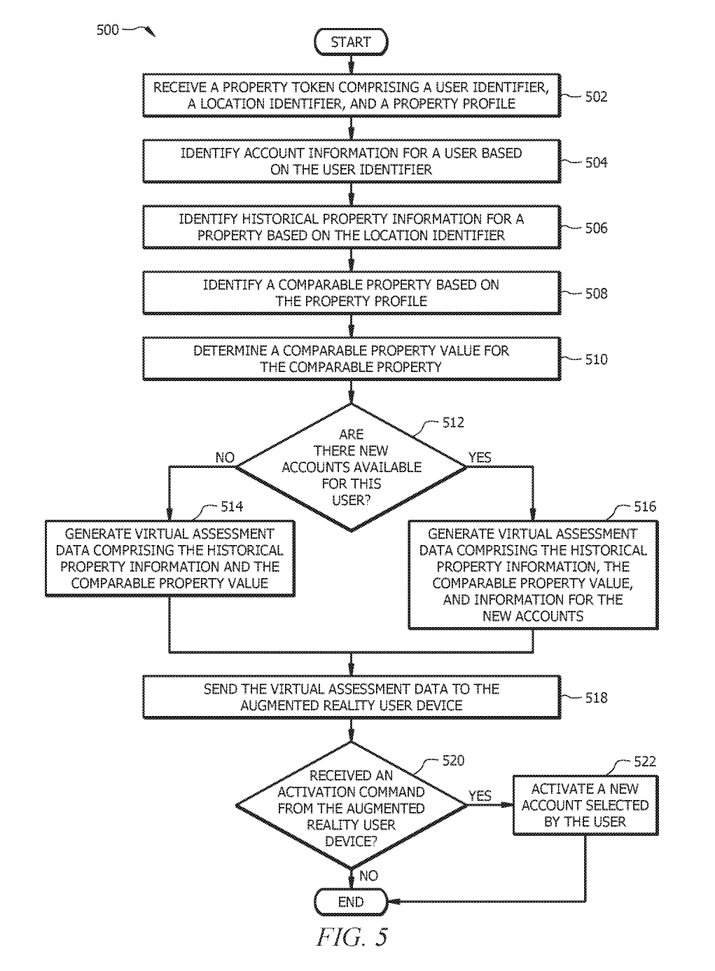

FIG. 1 illustrates an example of a user employing an augmented reality user device to view virtual objects overlaid with tangible objects in a real scene in front of the user. FIG. 2 is an embodiment of how an augmented reality user device may be configured and implemented. FIGS. 3, 6, and 9 provide examples of a first person view of what a user might see when using the augmented reality user device to view virtual objects overlaid with tangible objects. FIGS. 4, 7, and 10 are examples of a process for facilitating augmented reality overlays with tangible objects using an augmented reality user device. FIGS. 5, 8, and 11 are examples of a process for facilitating augmented reality overlays with tangible objects with a remote server.

FIG. 1 is a schematic diagram of an embodiment of an augmented reality system 100 configured to overlay virtual objects with a real scene. The augmented reality system 100 comprises an augmented reality user device 200 in signal communication with a remote server 102 via a network 104. The augmented reality user device 200 is configured to employ any suitable connection to communicate data with the remote server 102. In FIG. 1, the augmented reality user device 200 is configured as a head-mounted wearable device. Other examples of wearable devices are integrated into a contact lens structure, an eye glass structure, a visor structure, a helmet structure, or any other suitable structure. In some embodiments, the augmented reality user device 200 may be integrated with a mobile user device 103. Examples of mobile user devices 103 include, but are not limited to, a mobile phone, a computer, a tablet computer, and a laptop computer. For example, the user 106 may use a smart phone as the augmented reality user device 200 to overlay virtual objects with a real scene. Additional details about the augmented reality user device 200 are described in FIG. 2.

Examples of an augmented reality user device 200 in operation are described below and in FIGS. 4, 7, and 10. The augmented reality user device 200 is configured to identify and authenticate a user 106 and to provide a user identifier 108 that identifies the user 106. The user identifier 108 is a label or descriptor (e.g. a name based on alphanumeric characters) used to identify the user 106. The augmented reality user device 200 is configured to use one or more mechanisms such as credentials (e.g. a log-in and password) or biometric signals to identify and authenticate the user 106.

The augmented reality user device 200 is configured to identify the location of the user 106 and to generate a location identifier 112 identifying the location of the user 106 and a property 150. The location identifier 112 is a label or descriptor that identifies the property 150 and/or the location of the property 150. For example, a location identifier 112 may identify an address of the property 150 or a global position system (GPS) coordinate for the property 150. In other examples, the location identifier 112 may use any other types of descriptors to indicate the location of the property 150. Examples of properties 150 include, but are not limited to, single family homes, multi-family homes, townhomes, condos, apartments, and commercial properties.

In one embodiment, the augmented reality user device 200 identifies the location of the user 106 based on the geographic location of the user 106. For example, the augmented reality user device 200 uses geographic location information provided by a GPS sensor with a map database to determine the location of the user 106. In another embodiment, the augmented reality user device 200 is configured to use object recognition and/or optical character recognition to identify the location of the user 106. For example, the augmented reality user device 200 is configured to identify the location of the user 106 based on the identification of buildings, structures, landmarks, signs, and/or any other types of objects around the user 106. In another embodiment, the augmented reality user device 200 identifies the location of the user 106 and the property 150 based on a user input, for example, a voice command, a gesture, an input from a user interface. In other embodiments, the augmented reality user device 200 determines the location of the user 106 based on any other information and/or using any other suitable technique as would be appreciated by one of ordinary skill in the art.

The augmented reality user device 200 is configured to identify tangible objects in front of the user 106. For example, the augmented reality user device 200 is configured to identify features of a property 150. Examples of features includes, but are not limited to, structures, furniture, walls, floors, windows, fireplaces appliances, materials, fixtures, physical damage, defects, or any other tangible objects. The augmented reality user device 200 is configured to use object recognition and/or optical character recognition to identify objects and features of the property 150. In one embodiment, the augmented reality user device 200 is configured to capture an image 207 of features and to perform object recognition and/or optical character recognition on the image 207 of the features to identify the features. The augmented reality user device 200 is configured to identify an object or feature based on the size, shape, color, texture, material, and/or any other characteristics of the object. For example, the augmented reality user device 200 identifies an appliance based on branding, text, or logos on the object or its packaging. The augmented reality user device 200 identifies features of the property 150 based on any characteristics of the features or using any other suitable technique as would be appreciated by one of ordinary skill in the art.

In one embodiment, the augmented reality user device 200 is further configured to determine a cost associated with a feature or damage to the property 150. The augmented reality user device 200 accesses a third-party database 118 to determine the cost associated with a features or damage. For example, the augmented reality user device 200 queries a third-party database 118 linked with a vendor of an object to determine the price of the objects. In one embodiment, the augmented reality user device 200 sends a message 113 identifying one or more features to the third-party database 118. For example, the message 113 comprises descriptors for the features. Examples of descriptors include, but are not limited to, images 207 of the features, names, barcodes, object descriptors (e.g. type, size, or weight), and/or any other suitable descriptor for identifying the features.

The augmented reality user device 200 is configured to generate a property profile 114 for the property 150. A property profile 114 comprises information about the property 150 such as features of the property 150 and/or damage to the property 150. For example, a property profile 114 indicates the size (e.g. square footage) of the property 150, the age of the property 150, property type (e.g. single family, multi-family, or commercial), number of rooms (e.g. bedrooms and bathrooms), features, damage, any other information about the property 150, or combinations of information. The augmented reality user device 200 is configured to generate the property report 114 based on information provided by the user 106 and/or information obtained from performing object recognition.

The augmented reality user device 200 is configured to generate a property token 110 for requesting information for the user 106. In one embodiment, the augmented reality user device 200 generates a property token 110 comprising a user identifier 108 for the user 106, a location identifiers 112, and a property profile 114 corresponding with a real estate property (e.g. a home or office building) when the user 106 wants to aggregate information about a property 150. In another embodiment, the augmented reality user device 200 generates a property token 110 comprising a user identifier 108, user history data, and a location identifier 112 when the user 106 wants to aggregate information about the area around a property 150. In another embodiment, the augmented reality user device 200 generates a property token 100 comprising a location identifier 112 and a property profile 114 when the user 106 wants to aggregate information related to a project on the property 150. In other embodiments, the augmented reality user device 200 generate a property token 110 comprising any other information or combinations of information.

The augmented reality user device 200 is configured to send the property token 110 to the remote server 102. In one embodiment, the augmented reality user device 200 is configured to encrypt and/or encode the property token 110 prior to sending the property token 110 to the remote server 102. The augmented reality user device 200 employs any suitable encryption and/or encoding technique as would be appreciated by one of ordinary skill in the art.

The augmented reality user device 200 is further configured to receive virtual assessment data 111 from the remote server 102 in response to sending the token 110 to the remote server 102. The augmented reality user device 200 is configured to process the virtual assessment data 111 to access the information provided by the remote server 102. The virtual assessment data 111 comprises information related to the user 106, the location of the user 106, the property 150 the user 106 is looking at, a project for the property 150, and/or any other information for the user 106. The augmented reality user device 200 is configured to present information from the received virtual assessment data 111 as one or more virtual objects overlaid with the tangible objects in the real scene in front of the user 106. Examples of the augmented reality user device 200 presenting information as virtual objects overlaid with the objects in front of the user 106 are described in FIGS. 3, 6, and 9.

In one embodiment, the augmented reality user device 200 is configured to determine whether there are any new accounts available for the user 106. For example, the augmented reality user device 200 determines there are offers available for the user 106 based on the presence of information for new accounts in the received virtual assessment data 111. The augmented reality user device 200 is configured to present the information about available new accounts for the user 106 as virtual objects overlaid with the objects in front of the user 106. In some embodiments, one or more of the available new accounts involve activation by the user 106 in order to be used by the user 106. The augmented reality user device 200 is further configured to determine whether the user 106 selects a new account to activate. The user 106 selects or identifies a new account from among the one or more available new accounts when the user 106 wants to activate the new account. The augmented reality user device 200 is configured to receive an indication of the selected new account from the user 106 as a voice command, a gesture, an interaction with a button on the augmented reality user device 200, or in any other suitable form. The augmented reality user device 200 is configured to send an activation command 128 identifying the selected new account to the remote server 102 to activate the new account.

The network 104 comprises a plurality of network nodes configured to communicate data between the augmented reality user device 200 and one or more servers 102 and/or third-party databases 118. Examples of network nodes include, but are not limited to, routers, switches, modems, web clients, and web servers. The network 104 is configured to communicate data (e.g. property tokens 110 and virtual assessment data 111) between the augmented reality user device 200 and the server 102. Network 104 is any suitable type of wireless and/or wired network including, but not limited to, all or a portion of the Internet, the public switched telephone network, a cellular network, and a satellite network. The network 104 is configured to support any suitable communication protocols as would be appreciated by one of ordinary skill in the art upon viewing this disclosure.

The server 102 is linked to or associated with one or more institutions. Examples of institutions include, but are not limited to, organizations, businesses, government agencies, financial institutions, and universities, among other examples. The server 102 is a network device comprising one or more processors 116 operably coupled to a memory 120. The one or more processors 116 are implemented as one or more central processing unit (CPU) chips, logic units, cores (e.g. a multi-core processor), field-programmable gate array (FPGAs), application specific integrated circuits (ASICs), or digital signal processors (DSPs). The one or more processors 116 are communicatively coupled to and in signal communication with the memory 120. The one or more processors 116 are configured to process data and may be implemented in hardware or software. The one or more processors 116 are configured to implement various instructions. For example, the one or more processors 116 are configured to implement a real estate compiler engine 122. In an embodiment, the real estate compiler engine 122 is implemented using logic units, FPGAs, ASICs, DSPs, or any other suitable hardware.

Examples of the real estate compiler engine 122 in operation are described in detail below and in FIGS. 5, 8, and 11. In one embodiment, the real estate compiler engine 122 is configured to receive a property token 110 and to process the property token 110 to identify a user identifier 108 for the user 106, user history data for the user 106, a location identifiers 112 identifying the location of the user 106, a property profile 114, and/or any other information. In one embodiment, processing the property token 110 comprises decrypting and/or decoding the property token 110 when the property token 110 is encrypted or encoded by the augmented reality user device 200. The real estate compiler engine 122 employs any suitable decryption or decoding technique as would be appreciated by one of ordinary skill in the art.

The real estate compiler engine 122 is configured to use the user identifier 108 to look-up and identify account information for the user 106 in an account information database 120. The account information comprises one or more accounts (e.g. payment accounts), budgeting information, transaction history, membership information (e.g. loyalty or reward program memberships), and/or any other information linked with the user 106. Examples of accounts include, but are not limited to, checking accounts, savings accounts, investment accounts, credit card accounts, lines of credit, and any other suitable type of account.

In one embodiment, the real estate compiler engine 122 is configured to determine whether there are any new accounts available for the user 106 based on the user's account information, a listed property value, an estimated renovation cost, or any other suitable information. Examples of new accounts include, but are not limited to, credit cards, loans, lines of credit, and any other financing options. For example, the real estate compiler engine 122 identifies lines of credit or loans available to the user 106 based on their account information (e.g. credit score). In this example, the real estate compiler engine 122 prequalifies the user 106 for a new line a credit based on their account information.

In another embodiment, the real estate compiler engine 122 is configured to send a data request 127 comprising information provided by the property token 110 and/or account information for the user 106 to one or more third-party databases 118 to query the third-party databases 118 for available new accounts for the user 106. For example, a third-party database 118 is linked with a lender and provides information about available new accounts for the user 106 in response to the data request 127. In one embodiment, the data request 127 comprises the user identifier 108, account information for the user 106, information provided by the property token 110, any other information linked with the user 106, or combinations of information.

The real estate compiler engine 122 is configured to generate virtual assessment data 111 that comprises aggregated information for the user 106 and sends the aggregated information to the augmented reality user device 200. Examples of the real estate compiler engine 122 aggregating information for to be transmitted as virtual assessment data 111 to the augmented reality user device 200 are described in FIGS. 5, 8, and 11.

The real estate compiler engine 122 is further configured to receive an activation command 128 identifying a selected new account by the user 106. The real estate compiler engine 122 is configured to identify the selected new account and to facilitate activating the selected new account for the user 106. For example, the real estate compiler engine 122 is configured to exchange messages with a third-party database 118 to activate the selected new account for the user 106. Once a new account is activated, the user 106 may use the selected new account. In one embodiment, the real estate compiler engine 122 is configured to send virtual assessment data 111 to the augmented reality user device 200 that indicates the selected new account has been activated.

The memory 120 comprises one or more disks, tape drives, or solid-state drives, and may be used as an over-flow data storage device, to store programs when such programs are selected for execution, and to store instructions and data that are read during program execution. The memory 120 may be volatile or non-volatile and may comprise read-only memory (ROM), random-access memory (RAM), ternary content-addressable memory (TCAM), dynamic random-access memory (DRAM), and static random-access memory (SRAM). The memory 120 is operable to store an account information database 124, tax information database 126, real estate information database 128, real estate compiler instructions 130, and/or any other data or instructions. The real estate compiler instructions 130 comprises any suitable set of instructions, logic, rules, or code operable to execute the real estate compiler engine 122.

The account information database 124 comprises account information for the user 106. Account information includes, but is not limited to, personal information, credit scores, credit history, institution names, account names, account balances, account types, budget information, rewards points, member benefits, transaction history, and payment history. The tax information database 126 is configured to store property tax information, local tax information, school tax information, and any other kinds of tax information. The real estate information database 128 is configured to store real estate information, map information, product information, financial product information, repair contractor information, historical property sales information, public records, police records, financial product information (e.g. loan information), tax information, permit information, insurance claims information, property lien information, demographic information, crime information, traffic information, and/or any other information. In an embodiment, the account information database 124, the tax information database 126, and/or the real estate information database 128 are stored in a memory external of the server 102. For example, the server 102 is operably coupled to a remote database storing the account information database 124, the tax information database 126, and/or the real estate information database 128.

In one embodiment, the server 102 is in signal communication with one or more third-party databases 118. Third-party databases 118 are databases owned or managed by a third-party source. Examples of third-party sources include, but are not limited to, vendors, institutions, and businesses. In one embodiment, the third-party databases 118 are configured to store account information for the user 106, real estate information, map information, product information, historical property sales information, public records, financial product information (e.g. loan information), tax information, insurance claims information, property lien information, demographic information, crime information, traffic information, and/or any other information. In one embodiment, third-party databases 118 are configured to push (i.e. send) data to the server 102. The third-party database 118 is configured to send information to the server 102 with or without receiving a data request for the information. The third-party database 118 is configured to send data periodically to the server 102, for example, hourly, daily, or weekly. For example, the third-party database 118 is configured to push real estate information about one or more neighborhoods to the server 102 hourly.

In another embodiment, a third-party database 118 is configured to receive a data request 127 for information from the server 102. The third-party database 118 is configured to send the requested information back to the server 102. For example, a third-party database 118 is configured to receive a data request 127 comprising the location identifier 112 and/or property profile 114. The third-party database 118 is configured to use the location identifier 112 and property profile 114 to look-up information for the user 106 within the records of the third-party database 118. In other examples, third-party databases 118 are configured to use any information provided to the server 102 to look-up information.

In one embodiment, the third-party databases 118 are configured to receive a message 113 comprising descriptors for one or more objects or features from the augmented reality user device 200. For example, the augmented reality user device 200 sends a message 113 comprising descriptors for features (e.g. fixtures and appliances) of a property 150 to request pricing information for the features and/or information about alternative features for the property 150. The third-party databases 118 are configured to use the descriptors to look-up prices and/or any other information linked with the objects described by the descriptors. The third-party databases 118 are configured to send the requested information to the augmented reality user device 200.

FIG. 2 is a schematic diagram of an embodiment of an augmented reality user device 200 employed by the augmented reality system 100. The augmented reality user device 200 is configured to capture an image 207 of an object (e.g. a property 150 or property features), to send a property token 110 identifying the user 106 and/or the property 150 to a remote server 102, to receive virtual assessment data 111 in response to sending the property token 110, and to present virtual objects overlaid onto one or more tangible objects in a real scene in front of the user 106 based on the information provided by the virtual assessment data 111. Examples of the augmented reality user device 200 in operation are described in FIGS. 4, 7, and 10.

The augmented reality user device 200 comprises a processor 202, a memory 204, a camera 206, a display 208, a wireless communication interface 210, a network interface 212, a microphone 214, a GPS sensor 216, and one or more biometric devices 218. The augmented reality user device 200 may be configured as shown or in any other suitable configuration. For example, augmented reality user device 200 may comprise one or more additional components and/or one or more shown components may be omitted.

Examples of the camera 206 include, but are not limited to, charge-coupled device (CCD) cameras and complementary metal-oxide semiconductor (CMOS) cameras. The camera 206 is configured to capture images 207 of people, text, and objects within a real environment. The camera 206 is configured to capture images 207 continuously, at predetermined intervals, or on-demand. For example, the camera 206 is configured to receive a command from a user to capture an image 207. In another example, the camera 206 is configured to continuously capture images 207 to form a video stream of images 207. The camera 206 is operable coupled to an object recognition engine 224, an optical character (OCR) recognition engine 226, and/or a gesture recognition engine 228 and provides images 207 to the object recognition engine 224, the OCR recognition engine 226, and/or the gesture recognition engine 228 for processing, for example, to identify gestures, text, and/or objects in front of the user.

The display 208 is configured to present visual information to a user in an augmented reality environment that overlays virtual or graphical objects onto tangible objects in a real scene in real-time. In an embodiment, the display 208 is a wearable optical head-mounted display configured to reflect projected images and allows a user to see through the display 208. For example, the display 208 may comprise display units, lens, semi-transparent mirrors embedded in an eye glass structure, a contact lens structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matric OLED (AMOLED), an organic LED (OLED) display, a projector display, or any other suitable type of display as would be appreciated by one of ordinary skill in the art upon viewing this disclosure. In another embodiment, the display 208 is a graphical display on a user device. For example, the graphical display may be the display of a tablet or smart phone configured to display an augmented reality environment with virtual or graphical objects overlaid onto tangible objects in a real scene in real-time.

Examples of the wireless communication interface 210 include, but are not limited to, a Bluetooth interface, a radio frequency identifier (RFID) interface, a near-field communication (NFC) interface, a local area network (LAN) interface, a personal area network (PAN) interface, a wide area network (WAN) interface, a Wi-Fi interface, a ZigBee interface, or any other suitable wireless communication interface as would be appreciated by one of ordinary skill in the art upon viewing this disclosure. The wireless communication interface 210 is configured to allow the processor 202 to communicate with other devices. For example, the wireless communication interface 210 is configured to allow the processor 202 to send and receive signals with other devices for the user (e.g. a mobile phone) and/or with devices for other people. The wireless communication interface 210 is configured to employ any suitable communication protocol.

The network interface 212 is configured to enable wired and/or wireless communications and to communicate data through a network, system, and/or domain. For example, the network interface 212 is configured for communication with a modem, a switch, a router, a bridge, a server, or a client. The processor 202 is configured to receive data using network interface 212 from a network or a remote source.

Microphone 214 is configured to capture audio signals (e.g. voice commands) from a user and/or other people near the user. The microphone 214 is configured to capture audio signals continuously, at predetermined intervals, or on-demand. The microphone 214 is operably coupled to the voice recognition engine 222 and provides captured audio signals to the voice recognition engine 222 for processing, for example, to identify a voice command from the user.

The GPS sensor 216 is configured to capture and to provide geographical location information. For example, the GPS sensor 216 is configured to provide the geographic location of a user employing the augmented reality user device 200. The GPS sensor 216 is configured to provide the geographic location information as a relative geographic location or an absolute geographic location. The GPS sensor 216 provides the geographic location information using geographic coordinates (i.e. longitude and latitude) or any other suitable coordinate system.

Examples of biometric devices 218 include, but are not limited to, retina scanners and finger print scanners. Biometric devices 218 are configured to capture information about a person's physical characteristics and to output a biometric signal 231 based on captured information. A biometric signal 231 is a signal that is uniquely linked to a person based on their physical characteristics. For example, a biometric device 218 may be configured to perform a retinal scan of the user's eye and to generate a biometric signal 231 for the user based on the retinal scan. As another example, a biometric device 218 is configured to perform a fingerprint scan of the user's finger and to generate a biometric signal 231 for the user based on the fingerprint scan. The biometric signal 231 is used by a biometric engine 232 to identify and/or authenticate a person. In one embodiment, the biometric device 218 are configured to collect health information or vitals for a use as biometric signals 231. Examples of health information includes, but is not limited to, heart rate, blood sugar, eye dilation, and perspiration levels.

The processor 202 is implemented as one or more CPU chips, logic units, cores (e.g. a multi-core processor), FPGAs, ASICs, or DSPs. The processor 202 is communicatively coupled to and in signal communication with the memory 204, the camera 206, the display 208, the wireless communication interface 210, the network interface 212, the microphone 214, the GPS sensor 216, and the biometric devices 218. The processor 202 is configured to receive and transmit electrical signals among one or more of the memory 204, the camera 206, the display 208, the wireless communication interface 210, the network interface 212, the microphone 214, the GPS sensor 216, and the biometric devices 218. The electrical signals are used to send and receive data and/or to control or communicate with other devices. For example, the processor 202 transmit electrical signals to operate the camera 206. The processor 202 may be operably coupled to one or more other devices (not shown).

The processor 202 is configured to process data and may be implemented in hardware or software. The processor 202 is configured to implement various instructions. For example, the processor 202 is configured to implement a virtual overlay engine 220, a voice recognition engine 222, an object recognition engine 224, an OCR recognition engine 226, a gesture recognition engine 228, a virtual assessment engine 230, and a biometric engine 232. In an embodiment, the virtual overlay engine 220, the voice recognition engine 222, the object recognition engine 224, the OCR recognition engine 226, the gesture recognition engine 228, the virtual assessment engine 230, and the biometric engine 232 are implemented using logic units, FPGAs, ASICs, DSPs, or any other suitable hardware.

The virtual overlay engine 220 is configured to overlay virtual objects onto tangible objects in a real scene using the display 208. For example, the display 208 may be head-mounted display that allows a user to simultaneously view tangible objects in a real scene and virtual objects. The virtual overlay engine 220 is configured to process data to be presented to a user as an augmented reality virtual object on the display 208. Examples of overlaying virtual objects onto tangible objects in a real scene is shown in FIGS. 3, 6, and 9.

The voice recognition engine 222 is configured to capture and/or identify voice patterns using the microphone 214. For example, the voice recognition engine 222 is configured to capture a voice signal from a person and to compare the captured voice signal to known voice patterns or commands to identify the person and/or commands provided by the person. For instance, the voice recognition engine 222 is configured to receive a voice signal to authenticate a user and/or to identify a selected option or an action indicated by the user.

The object recognition engine 224 is configured to identify objects, object features, branding, text, and/or logos using images 207 or video streams created from a series of images 207. In one embodiment, the object recognition engine 224 is configured to identify objects and/or text within an image 207 captured by the camera 206. In another embodiment, the object recognition engine 224 is configured to identify objects and/or text in about real-time on a video stream captured by the camera 206 when the camera 206 is configured to continuously capture images 207. The object recognition engine 224 employs any suitable technique for implementing object and/or text recognition as would be appreciated by one of ordinary skill in the art upon viewing this disclosure.

The OCR recognition engine 226 is configured to identify objects, object features, text, and/or logos using images 207 or video streams created from a series of images 207. In one embodiment, the OCR recognition engine 226 is configured to identify objects and/or text within an image 207 captured by the camera 206. In another embodiment, the OCR recognition engine 226 is configured to identify objects and/or text in about real-time on a video stream captured by the camera 206 when the camera 206 is configured to continuously capture images 207. The OCR recognition engine 226 employs any suitable technique for implementing object and/or text recognition as would be appreciated by one of ordinary skill in the art upon viewing this disclosure.

The gesture recognition engine 228 is configured to identify gestures performed by a user and/or other people. Examples of gestures include, but are not limited to, hand movements, hand positions, finger movements, head movements, and/or any other actions that provide a visual signal from a person. For example, gesture recognition engine 228 is configured to identify hand gestures provided by a user to indicate various commands such as a command to initiate a request for an augmented reality overlay for an object. The gesture recognition engine 228 employs any suitable technique for implementing gesture recognition as would be appreciated by one of ordinary skill in the art upon viewing this disclosure.

The virtual assessment engine 230 is configured to identify the location of the user 106 and to generate a location identifier 112 identifying the location of the user 106 and a property 150. The virtual assessment engine 203 generates a location identifier 112 uses any suitable types of descriptors to indicate the location of the property 150.

In one embodiment, the virtual assessment engine 230 identifies the location of the user 106 based on the geographic location of the user 106. For example, the virtual assessment engine 230 uses geographic location information provided by the GPS sensor 216 with a map database to determine the location of the user 106. In another embodiment, the virtual assessment engine 230 is configured to use object recognition and/or optical character recognition to identify the location of the user 106. For example, the virtual assessment engine 230 is configured to identify the location of the user 106 based on the identification of buildings, structures, landmarks, signs, and/or any other types of objects around the user 106. In another embodiment, the virtual assessment engine 230 identifies the location of the user 106 and the property 150 based on a user input, for example, a voice command, a gesture, an input from a user interface. In other embodiments, the virtual assessment engine 230 determines the location of the user 106 based on any other information and/or using any other suitable technique as would be appreciated by one of ordinary skill in the art.

The virtual assessment engine 230 is configured to identify tangible objects in front of the user 106. For example, the virtual assessment engine 230 is configured to identify features of a property 150. The virtual assessment engine 230 is configured to use object recognition and/or optical character recognition to identify objects and features of the property 150. In one embodiment, the virtual assessment engine 230 is configured to capture an image 207 of features and to perform object recognition and/or optical character recognition on the image 207 of the features to identify the features. The virtual assessment engine 230 is configured to identify an object or feature based on the size, shape, color, texture, material, and/or any other characteristics of the object. The virtual assessment engine 230 identifies features of the property 150 based on any characteristics of the features or using any other suitable technique as would be appreciated by one of ordinary skill in the art.

In one embodiment, the virtual assessment engine 230 is configured to determine a cost associated with features, alternative features, or damage to the property 150. The virtual assessment engine 230 accesses a third-party database 118 to determine the cost associated with a features or damage. For example, the virtual assessment engine 230 queries a third-party database 118 linked with a vendor of an object to determine the price of the object. In one embodiment, the virtual assessment engine 230 sends a message 113 identifying one or more features to the third-party database 118. For example, the message 113 comprises descriptors for the features. In some embodiments, the virtual assessment engine 230 is configured to calculate a total cost associated with identified features. For example, the virtual assessment engine 230 is configured to calculate the sum of costs associated with features, alternative features, repairs, and/or damage to the property 150 to determine an estimated renovation cost.

The virtual assessment engine 230 is configured to collect user history data 229 for a user 106. Examples of user history data 229 include, but are not limited to, location history, internet search history, transaction history, biometric signal history, and/or any other kind of history for the user 106. In one embodiment, the virtual assessment engine 230 is configured to collect user history data 229 from one or more other devices such as a mobile device of the user or a third-party database 118. In other embodiments, the virtual assessment engine 230 is configured to collect user history data 229 from any suitable sources.

The virtual assessment engine 230 is configured to generate a property profile 114 for the property 150. A property profile 114 comprises information about the property 150 such as features of the property 150 and/or damage to the property 150. For example, a property profile 114 indicates the size (e.g. square footage) of the property 150, the age of the property 150, property type (e.g. single family, multi-family, or commercial), number of rooms (e.g. bedrooms and bathrooms), features, damage, any other information about the property 150, or combinations of information. The virtual assessment engine 230 is configured to generate the property report 114 based on information provided by the user 106 and/or information obtained from performing object recognition.

The virtual assessment engine 230 is configured to generate a property token 110 for requesting information for the user 106. The property token 110 comprises a user identifier 108, user history data 229, a location identifier 112, a property profile 114, any other information or combination of information. The virtual assessment engine 230 is further configured to encrypt and/or encode the property token 110. Encrypting and encoding the property token 110 obfuscates and mask information being communicated by the property token 110. Masking the information being communicated protects users and their information in the event of unauthorized access to the network and/or data occurs. The virtual assessment engine 230 employs any suitable encryption or encoding technique as would be appreciated by one of ordinary skill in the art.

The virtual assessment engine 230 is configured to send the property token 110 to a remote server 102 as a data request to initiate the process of obtaining information for the user 106. The virtual assessment engine 230 is further configured to provide the information (e.g. virtual overlay data 111) received from the remote server 102 to the virtual overlay engine 220 to present the information as one or more virtual objects overlaid with tangible objects in a real scene. Examples of employing the virtual assessment engine 230 to request information and present the information to a user 106 is described in FIGS. 4, 7, and 10.

In one embodiment, the virtual assessment engine 230 is further configured to employ the virtual overlay engine 420 to present one or more new accounts that are available for the user 106 and/or any other information. In one embodiment, the virtual assessment engine 230 is configured identify selected new accounts by the user 106. For example, the virtual assessment engine 230 is configured to identify a selected new account for the user 106 and to send an activation command 128 to the remote server 102 that identifies the selected new account to activate. The user 106 may identify a selection by giving a voice command, performing a gesture, interacting with a physical component (e.g. a button, knob, or slider) of the augmented reality user device 200, or any other suitable mechanism as would be appreciated by one of ordinary skill in the art.

The biometric engine 232 is configured to identify a person based on a biometric signal 231 generated from the person's physical characteristics. The biometric engine 232 employs one or more biometric devices 218 to identify a user based on one or more biometric signals 218. For example, the biometric engine 232 receives a biometric signal 231 from the biometric device 218 in response to a retinal scan of the user's eye and/or a fingerprint scan of the user's finger. The biometric engine 232 compares biometric signals 231 from the biometric device 218 to previously stored biometric signals 231 for the user to authenticate the user. The biometric engine 232 authenticates the user when the biometric signals 231 from the biometric devices 218 substantially matches (e.g. is the same as) the previously stored biometric signals 231 for the user. In one embodiment, the biometric engine 232 is configured to employ biometric device 218 to collect health information or vitals for a user 106.

The memory 204 comprise one or more disks, tape drives, or solid-state drives, and may be used as an over-flow data storage device, to store programs when such programs are selected for execution, and to store instructions and data that are read during program execution. The memory 204 may be volatile or non-volatile and may comprise ROM, RAM, TCAM, DRAM, and SRAM. The memory 204 is operable to store images 207, property tokens 110, user history data 229, biometric signals 231, virtual overlay instructions 234, voice recognition instructions 236, OCR recognition instructions 238, object recognition instructions 240, gesture recognition instructions 242, virtual assessment instructions 244, biometric instructions 246, and any other data or instructions.

Images 207 comprises images captured by the camera 206 and images from other sources. In one embodiment, images 207 comprise images used by the augmented reality user device 200 when performing object recognition and/or optical character recognition. Images 207 can be captured using camera 206 or downloaded from another source such as a flash memory device or a remote server via an Internet connection.

Biometric signals 231 are signals or data that is generated by a biometric device 218 based on a person's physical characteristics. Biometric signals 231 are used by the augmented reality user device 200 to identify and/or authenticate an augmented reality user device 200 user by comparing biometric signals 231 captured by the biometric devices 218 with previously stored biometric signals 231.

Property tokens 110 are generated by the virtual assessment engine 230 and sent to a remote server 102 to initiate the process of aggregating information for a user 106. Property tokens 110 comprise any suitable information for requesting information from the remote server 102 and/or one or more other sources (e.g. third-party databases 118). In one embodiment, a property token 110 is a message or a data request comprising a user identifier 108, a location identifier 112, a property profile 114, user history data, any other information or combinations of information. Examples of the augmented reality user device 200 generating and sending property tokens 110 to initiate a process for obtaining information are described in FIGS. 4, 7, and 10.

User history data 229 comprises information linked with the user 106. Examples of user history data 229 include, but are not limited to, internet search history, transaction history, geographic location history, social media history, shopping lists, wish lists, account information, membership information, biometric information, health information, vitals, and/or any other history linked with the user 106.

The virtual overlay instructions 234, the voice recognition instructions 236, the OCR recognition instructions 238, the object recognition engine 240, the gesture recognition instructions 242, the virtual assessment instructions 244, and the biometric instructions 246 each comprise any suitable set of instructions, logic, rules, or code operable to execute the virtual overlay engine 220, the voice recognition engine 222, the OCR recognition engine 226, the object recognition engine 224, the gesture recognition engine 228, the virtual assessment engine 230, and the biometric engine 232, respectively.

FIGS. 3-5 provide examples of how the augmented reality system 100 may operate when a user 106 wants to aggregate information about a real estate property 150. The property 150 may be a property that the user 106 already owns or a property that the user 106 is interested in purchasing. The following is a non-limiting example of how the augmented reality system 100 may operate when a user 106 is looking around a property 150. In this example, the user 106 is using the augmented reality user device 200 while walking around a property 150 and looking at various features of the property 150. The user 106 authenticates themselves before using the augmented reality user device 200 by providing credentials (e.g. a log-in and password) and/or a biometric signal. The augmented reality user device 200 authenticates the user 106 based on the user's input and allows the user 106 to generate and send property tokens 110. The augmented reality user device 200 identifies the user 106 and a user identifier 108 for the user 106 upon authenticating the user 106. Once the user 106 has been authenticated, the user identifier 108 is used by other systems and devices (e.g. remote server 102 and/or a third-party database 118) to identify and authenticate the user 106 without requiring the user 106 to provide additional credentials for each system.

Once the user 106 is authenticated, the augmented reality user device 200 identifies the location of the user 106. In one embodiment, the augmented reality user device 200 identifies the location of the user 106 based on the geographic location of the user 106. For example, the augmented reality user device 200 uses geographic location information provided by a GPS sensor with a map database (e.g. a third-party database 118) to determine the location of the user 106 and to identify the property 150 at that location. In another embodiment, the augmented reality user device 200 uses object recognition and/or optical character recognition to identify the property 150. For example, the augmented reality user device 200 identifies the property 150 based on structures, street signs, house numbers, building numbers, or any other objects. In other embodiments, the augmented reality user device 200 identifies the location of the user 106 and the property 150 using any other suitable information. The augmented reality user device 200 generates or determines a location identifier 112 that identifies the location of the property 150.

The user 106 walks around the property 150 and looks at various features of the property 150, for example, flooring, fixtures, amenities, appliances, and damage. The augmented reality user device 200 captures images 207 of the property 150 and identifies the different features of the property 150 based on the captured images 207. The augmented reality user device 200 generates a property profile 114 based on the features of the property 150.

The augmented reality user device 200 generates a property token 110 and sends the property token 110 to the remote server 102. In one embodiment, the augmented reality user device 200 generates a property token 110 comprising the user identifier 108, the location identifier 112, and the property profile 114. In other embodiments, the augmented reality user device 200 generates a property token 110 comprising any other suitable information or combinations of information. The augmented reality user device 200 encrypts and/or encodes the property token 110 prior to sending the property token 110 to the remote server 102.

The server 102 receives the property token 110 and processes the property token 110 to identify the user identifier 108, the location identifier 112, and the property profile 114. The server 102 decrypts or decodes the property token 110 when the property token 110 is encrypted or encoded by the augmented reality user device 200. The server 102 uses the user identifier 108 to look-up account information and/or accounts for the user 106 in the account information database 124.

In one embodiment, the server 102 is configured to determine whether there are any new accounts available for the user 106 based on the user's account information, the location identifier 112, and/or the property profile 114. Examples of new accounts include, but are not limited to, credit cards, loans, lines of credit, and any other financing option. For example, the server 102 identifies a line of credit or loan available to the user 106 based on their account information (e.g. credit score). In this example, the server 102 prequalifies the user 106 for a new line of credit based on their account information. In another embodiment, the server 102 queries one or more third-party databases 118 for available new accounts based on the user's 106 identity (e.g. the user identifier 108), the property or the location of the property (e.g. the location identifier 112), and/or the property profile 114. For instance, a third-party database 118 is linked with a lender and provides information related to lines of credit accounts and other financing options.

The server 102 identifies and aggregates historical property information for the property 150 based on the location identifier 112. Examples of historical property information includes, but is not limited to, historical property sales information, tax information, public records, insurance claims information, and any other information for the property 150 linked with the location identifier 112. For example, the server 102 uses the location identifier 112 to identify historical property information in the tax information database 126 and/or the real estate information database 128. As another example, the server 102 sends a data request 127 with the location identifier 112 to a third-party database 118 to request historical property information for the property 150. The server 102 receives historical property information for the property 150 based on the location identifier 112.

The server 102 identifies one or more comparable properties based on the property profile 114. The server 102 uses information provided by the property profile 114 to identify comparable properties with similar features and/or in a similar neighborhood. The server 102 identifies comparable properties using any information or technique as would be appreciated by one of ordinary skill in the art. In one embodiment, the server 102 uses information from the property profile 114 to identify comparable properties in the real estate information database 128. In another embodiment, the server 102 sends a data request 127 with information from the property profile 114 to request information about comparable properties. The server 102 determines a comparable property value for the one or more comparable properties. The comparable property value is price of a comparable property with similar features and/or in a similar neighborhood as the property 150 the user 106 is looking at. The comparable property value may obtained from aggregated information about comparable properties. For example, the comparable property value may be obtained from information provided by the real estate information database 128 and/or a third-party database 118.

The server 102 generates virtual assessment data 111 that comprises the historical property information, the comparable property value, information about available new accounts, any other information, or combinations of information. The server 102 sends the virtual assessment data 111 to the augmented reality user device 200.

The augmented reality user device 200 receives the virtual assessment data 111 and processes the virtual assessment data 111 to access the information provided by the server 102. In one embodiment, the augmented reality user device 200 presents the historical property information and the comparable property value as virtual objects overlaid with tangible objects in real scene in front of the user 106. In other embodiments, the augmented reality user device 200 presents any other information as virtual objects overlaid with tangible objects in the real scene in front of the user 106. The user 106 may use the information presented by the augmented reality user device 200 to quickly analyze the property 150 and/or to make a decision about the property 150 while seeing the information presented in the context of the real scene in front of the user 106. An example of the augmented reality user device 200 presenting information to the user 106 as virtual objects overlaid with tangible objects in a real scene in front of the user 106 is described in FIG. 3.

In one embodiment, the augmented reality user device 200 determines whether the are any new accounts available for the user 106. For example, the augmented reality user device 200 may determine whether there are any new accounts available for the user 106 to finance or purchase the property 150. The augmented reality user device 200 determines there are new accounts available for the user 106 based on the presence of information linked with the new accounts in the virtual assessment data 111. The augmented reality user device 200 presents the new accounts available to the user 106 as virtual objects overlaid with tangible objects in the real scene in front of the user 106. When the augmented reality user device 200 presents the one or more available new accounts, the augmented reality user device 200 determines whether the user 106 selects a new account to activate. The augmented reality user device 200 receives the indication of the selected new account from the user 106 as a voice command, a gesture, an interaction with a button on the augmented reality user device 200, or in any other suitable form. The augmented reality user device 200 sends an activation command 128 identifying the selected new account to the remote server 102. The augmented reality user device 200 allows the user 106 to quickly identify any new accounts the user 106 is prequalified for based on their personal information without the user 106 having to manually search for and apply for different accounts. The augmented reality user device 200 also provides the ability for the use 106 to activate one of the new accounts using previously stored account information for each account they would like to activate.

The server 102 receives the activation command 128 identifying the selected new account and facilitates activating the selected new account for the user 106. For example, the sever 102 exchanges messages with a third-party database 118 to activate the selected new account for the user 106. The server 102 uses account information for the user 106 or any other information to activate the new account. For instance, the server 102 uses credit information and personal information for the user 106 to activate the new account. In one embodiment, the server 102 sends virtual assessment data 111 to the augmented reality user device 200 that indicates the selected new account has been activated. The activation notification may be presented to the user 106 by the augmented reality user device 200 as a virtual object.

FIG. 3 is an embodiment of a first person view from a display 208 of an augmented reality user device 200 overlaying virtual objects 302 with tangible objects 304 within a real scene 300. Examples of tangible object 304 include, but are not limited to, fixtures, appliances, property features, floors, walls, furniture, people, or any other physical objects. In FIG. 3, a user 106 is walking around a property (e.g. a home) they are interested in purchasing using the augmented reality user device 200. The augmented reality user device 200 generates a location identifier 112 identifying the property 150 and/or the location of the property 150.

The user 106 is looking around the interior of the property at various objects and features of the property 150. The user 106 is also looking for any potential damage or other things that may reduce the value of the property 150. The user 106 employs the augmented reality user device 200 to identify features and damage to the property 150 and to request information about the property 150 based on the identified features and damage. In one embodiment, the augmented reality user device 200 identifies the different features or damage using virtual objects 302. For example, the augmented reality user device 200 identifies hardwood floors 305 in the property 150 using virtual object 306. Virtual object 306 identifies the location of the feature (i.e. the hardwood floors 305) and indicates that the feature likely increases the value of the property 150. The augmented reality user device 200 identifies foundation damage 308 and indicates the location of the foundation damage 308 using a virtual object 310. Virtual object 310 indicates that the damage decreases the value of the property 150. The augmented reality user device 200 identifies a damaged window 312 and indicates the location of the damaged window 312 using a virtual object 314. The virtual object 314 indicates that the damage decreases the value of the property 150. The augmented reality user device 200 identifies any other features of and/or damage to the property 150.

In an embodiment, the augmented reality user device 200 determines a cost associated with identified features and damage to the property 150. For example, the augmented reality user device 200 queries a third-party database 118 to determine the cost associated with the identified features and damage. For instance, the augmented reality user device 200 sends a message 113 identifying the features and/or damage to the property 150 to a third-party database 118. The message 113 may use descriptors to identify the features and damage. Examples of descriptors include, but are not limited to, images 207 of the features and damage, text-based descriptions, names, object descriptors (e.g. type, size, or weight), and/or any other suitable descriptors for identifying the features and damage. The augmented reality user device 200 receives costs associated with the identified features and damage in response to sending the message 113 to the third-party database 118.

In an embodiment, the augmented reality user device 200 employs other sensors to identify features or characteristics of the property 150. For example, the augmented reality user device 200 uses the microphone 214 to measure the noise level of the property 150. The augmented reality user device 200 presents the measured noise level as a virtual object 316. As another example, the augmented reality user device 200 uses the camera 206 to estimate the size of the property, for example, the square footage. For instance, while the user 106 is look around the property 150 and the augmented reality user device 200 determines the size of the property 150. The augmented reality user device 200 presents the estimated square footage as a virtual object 318. In other examples, the augmented reality user device 200 measures any other features or characteristics of the property 150 and presents the measurements as a virtual object 302 overlaid with the real scene in front of the user 106. The augmented reality user device 200 may present measurements using any suitable units of measurements.

The augmented reality user device 200 generates a property profile 114 based on the identified features of the property 150. In this example, the augmented reality user device 200 generates a property profile 114 that comprises information about the hardwood floors 305, the foundation damage 308, the window damage 312, the noise level, the estimated square footage, any other information or combinations of information. The augmented reality user device 200 generates a property token 110 comprising a user identifier 108, a location identifier 112, and the property profile 114. The augmented reality user device 200 sends the property token 110 to the remote server 102 to request information for the user 106 about the property 150.

The information about the property 150 may be determined based on information from multiple sources. For example, tax information may be stored in the remote server 102 and information about other comparable properties may be located in one or more third-party databases 118. In other examples, the information about the property 150 may be located in any other source or combinations of sources. Property tokens 110 allow the augmented reality user device 200 to request the information regardless of the number of sources used to compile the requested information. The augmented reality user device 200 is able to request information without knowledge of which sources or how many sources need to be queried for the information.

In response to sending the property token 110, the augmented reality user device 200 receives virtual assessment data 111 from the remote server 102. In one embodiment, the virtual assessment data 111 comprises historical property information for the property and a comparable property value. In FIG. 3, the historical property information includes a listed property value for the property 150. The augmented reality user device 200 presents the listed property value as a virtual object 318. The comparable property value indicates the price of a comparable property, for example, a property with similar features in a similar neighborhood. The augmented reality user device 200 presents the comparable property value as a virtual object 320. In this example, the augmented reality user device 200 allows the user 106 to quickly assess how the property 150 compares to other properties.

In one embodiment, the augmented reality user device 200 is configured to determines an adjusted property value for the property 150 based on the identified features and damage to the property 150. For example, the augmented reality user device 200 adds to or subtracts from the listed property value or a tax assessor property value based on the identified features and damage. As another example, the augmented reality user device 200 compares the identified features with received aggregated information (e.g. public records and permit information) and adjusts the listed property value based on the comparison. For example, the augmented reality user device 200 reduces the listed property value when the identified features are inconsistent or different from features described in public records. As another example, the augmented reality user device 200 reduces the listed property value when the property 150 has had numerous insurance claims or currently has a lien on the property 150. As another example, the augmented reality user device 200 uses the comparable property value as the adjusted property value. In another example, the virtual assessment data 111 comprises the adjusted property value for the property 150. In other examples, the augmented reality user device 200 determines the adjusted price for the property 150 using any other technique. The augmented reality user device 200 presents the adjusted property value as a virtual object 322.

FIG. 4 is a flowchart of an embodiment of an augmented reality overlaying method 400 for an augmented reality user device 200. Method 400 is employed by the processor 202 of the augmented reality user device 200 to generate a property token 110 based on the user 106 of the augmented reality user device 200 and the location of the user 106, for example, a property 150 the user 106 is looking at. The augmented reality user device 200 uses the property token 110 to request information about the property 150 the user 106 is looking at as virtual objects overlaid with tangible objects in a real scene in front of the user 106.

At step 402, the augmented reality user device 200 authenticates a user 106. The user 106 authenticates themselves by providing credentials (e.g. a log-in and password) or a biometric signal. The augmented reality user device 200 authenticates the user 106 based on the user's input. The user 106 is able to generate and send property tokens 110 using the augmented reality user device 200 upon authenticating the user 106.

At step 404, the augmented reality user device 200 identifies a user identifier 108 for the user 106. Once the user 106 has been authenticated, the augmented reality user device 200 identifies the user 106 and a user identifier 108 for the user 106. The user identifier 108 may be used to identify and authenticate the user 106 in other systems, for example, third-party databases 118.

At step 406, the augmented reality user device 200 generates a location identifier 112 identifying the location of a property 150. In one embodiment, the augmented reality user device 200 uses geographic location information provided by the GPS sensor 216 with a map database to determine the location of the user 106 and to property 150. In another embodiment, the augmented reality user device 200 uses object recognition and/or optical character recognition to identify the property 150 based on structures, street signs, house numbers, building numbers, or any other objects. In other embodiments, the augmented reality user device 200 uses a user input or any other information to generate a location identifier 112.

At step 408, the augmented reality user device 200 captures an image 207 of the property 150. In one embodiment, the user 106 provides a command or signal to the augmented reality user device 200 that triggers the camera 206 to capture an image 207 of the property 150. In another embodiment, the augmented reality user device 200 and the camera 206 are configured to continuously or periodically capture images 207.

At step 410, the augmented reality user device 200 performs object recognition on the image 207 to identify features of the property 150. For example, the augmented reality user device 200 identifies the features of the property 150 based on the size, shape, color, texture, material, and/or any other characteristics of the features. In other examples, the augmented reality user device 200 identifies features based on any other features of the products and/or using any other suitable technique.

At step 412, the augmented reality user device 200 generates a property profile 114 based on the identified features of the property 150. The property profile 114 comprises information about the property 150 such as features of the property 150 and/or damage to the property 150. For example, a property profile 114 indicates the size (e.g. square footage) of the property 150, the age of the property 150, property type, number of rooms, features, damage, any other information about the property 150, or combinations of information. The augmented reality user device 200 is configured to generate the property report 114 based on information provided by the user 106 and/or information obtained from performing object recognition.

At step 414, the augmented reality user device 200 generates a property token 110. In one embodiment, the augmented reality user device 200 generates a property token 110 comprising the user identifier 108, the location identifier 112, and the property profile 114. In other embodiments, the augmented reality user device 200 generates a property token 110 comprising any other information. At step 416, the augmented reality user device 200 sends the property token 110 to a remote server 102.

At step 418, the augmented reality user device 200 receives virtual assessment data 111 from the remote server 102 in response to sending the property token 110 to the remote server 102. In one embodiment, the virtual assessment data 111 comprises historical property information for the property 150 and a comparable property value. In other embodiments, the virtual assessment data 111 further comprises any other information about the property 150.

At step 420, the augmented reality user device 200 presents information from the virtual assessment data 111 as virtual objects in the real scene in front of the user 106. The augmented reality user device 200 presents the historical property information for the property 150, the comparable property value, and any other information provided by the virtual assessment data 111 as virtual objects overlaid with tangible objects in the real scene in front of the user 106.

At step 422, the augmented reality user device 200 determines whether to adjust the property value of the property 150. For example, the augmented reality user device 200 determines to adjust the property value of the property 150 in response to a user input or command. As another example, the augmented reality user device 200 may automatically determine to adjust the property value of the property 150 based on information provided by the virtual assessment data 111. When the augmented reality user device 200 determines to adjust the property value of the property 150, the augmented reality user device 200 proceeds to step 424. Otherwise, the augmented reality user device 200 may terminate method 400.

At step 424, the augmented reality user device 200 determines a listed property value for the property 150. For example, the received historical property information may comprise a listed property value for the property 150. As another example, the augmented reality user device 200 uses the comparable property value as the listed property value for the property 150. As another example, the augmented reality user device 200 determines the listed property value based on an input provided by the user 106. For instance, the user 106 may say or gesture the listed property value for the property 150. In other examples, the augmented reality user device 200 uses any other suitable technique for determining the listed property value for the property 150.

At step 426, the augmented reality user device 200 adjusts the listed property value based on the property profile 114. For example, the augmented reality user device 200 reduces the listed property value when the identified features in the property profile 114 are inconsistent or different from features described in public records. As another example, the augmented reality user device 200 increases the listed property value when the property profile 114 indicates features that increase the value of the property 150. In other examples, the augmented reality user device 200 adjusts the listed property value based on the property profile 114 using any other suitable criteria. At step 428, the augmented reality user device 200 presents the adjusted property value as a virtual object to the user 106.

FIG. 5 is a flowchart of an embodiment of an augmented reality overlaying method 500 for a server 102. Method 500 is employed by the real estate compiler engine 122 in the server 102 to provide information about a property 150 to a user 106 of the augmented reality user device 200 in response to receiving a property token 110 from the augmented reality user device 200.

At step 502, the real estate compiler engine 122 receives a property token 110 from the augmented reality user device 200. The real estate compiler engine 122 decrypts and/or decodes the property token 110 when the property token 110 is encrypted or encoded by the augmented reality user device 200. In one embodiment, the real estate compiler engine 122 processes the property token 110 to identify a user identifier 108, a location identifier 112, and a property profile 114. In other embodiments, the real estate compiler engine 122 processes the property token 110 to identify any other information.

At step 504, the real estate compiler engine 122 identifies account information for a user 106 based on the user identifier 108. For example, the real estate compiler engine 122 uses the user identifier 108 to look-up the account information and accounts for the user 106 in the account information database 124.

At step 506, the real estate compiler engine 122 identifies historical property information for a property 150 based on the location identifier 112. For example, the real estate compiler engine 122 uses the location identifier 112 to identify historical property information in the tax information database 126 and/or the real estate information database 128. As another example, the real estate compiler engine 122 sends a data request 127 with the location identifier 112 to a third-party database 118 to request historical property information for the property 150. The real estate compiler engine 122 receives historical property information for the property 150 based on the location identifier 112.

At step 508, the real estate compiler engine 122 identifies a comparable property based on the property profile 114. In one embodiment, the real estate compiler engine 122 uses information from the property profile 114 to identify comparable properties in the real estate information database 128. In another embodiment, the real estate compiler engine 122 sends a data request 127 with information from the property profile 114 to request information about comparable properties. At step 510, the real estate compiler engine 122 determines a comparable property value for the comparable property.

At step 512, the real estate compiler engine 122 determines whether there are any new accounts available for the user 106. In one embodiment, the real estate compiler engine 122 queries the account information database 124 for any available new accounts for the user 106 using the user identifier 108, account information for the user 106, location identifier 112, and/or the property profile 114. In another embodiment, the real estate compiler engine 122 sends a data request 127 to one or more third-party databases 118 to query the third-party databases 118 for available new accounts for the user 106 based on the user identifier 108, the account information for the user 106, location identifier 112, and/or the property profile 114.

In one embodiment, the real estate compiler engine 122 prequalifies the user 106 for a new account based on the user's 106 account information. For instance, the real estate compiler engine 122 uses a credit history or a credit score for the user 106 to identify new accounts for the user 106, for example, a credit card or a line of credit. In other examples, the real estate compiler engine 122 identifies new accounts for the user 106 using any other suitable information for the user 106.

The real estate compiler engine 122 proceeds to step 514 when there are no new accounts available for the user 106. At step 514, the real estate compiler engine 122 generates virtual assessment data 111 comprising the historical property information and the comparable property value. The real estate compiler engine 122 proceeds to step 516 when there are new accounts available for the user 106. At step 516, the real estate compiler engine 122 generates virtual assessment data 111 comprising the historical property information, the comparable property value, and information for the new accounts available for the user 106. At step 518, the real estate compiler engine 122 sends the virtual assessment data 111 to the augmented reality user device 200.

At step 520, the real estate compiler engine 122 determines whether the real estate compiler engine 122 has received an activation command 128 from the augmented reality user device 200. The real estate compiler engine 122 proceeds to step 522 when the real estate compiler engine 122 receives an activation command 128. Otherwise, the real estate compiler engine 122 may terminate method 500.

At step 522, the real estate compiler engine 122 activates the new account selected by the user 106. The received activation command 128 identifies a selected new account for the user 106. The real estate compiler engine 122 facilitates activating the selected new account. For example, the real estate compiler engine 122 exchanges messages with a third-party database 118 to activate the selected new account. As another example, the real estate compiler engine 122 updates the information in the account information database 124 to activate the selected new account. The real estate compiler engine 122 may employ any other suitable technique for activating the selected new account.

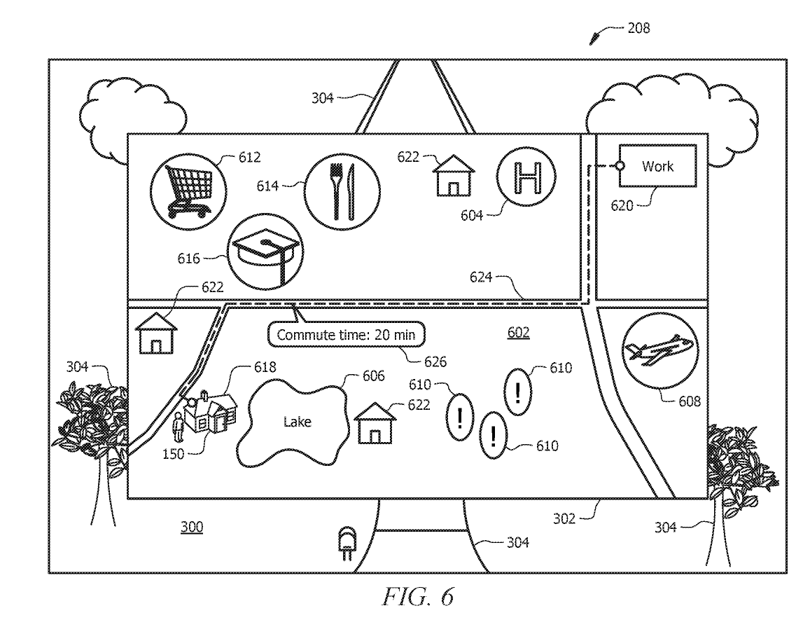

FIGS. 6-8 provide examples of how the augmented reality system 100 may operate when a user 106 wants to aggregate geolocation information about a real estate property 150 and its surrounding area. The following is another non-limiting example of how the augmented reality system 100 may operate when a user 106 wants to aggregate information about the area surrounding a property 150 the user 106 is looking at. The user 106 may be located within the property 150 or proximate to the property 150, for example, outside of the property 150. The user 106 authenticates themselves before using the augmented reality user device 200 by providing credentials (e.g. a log-in and password) and/or a biometric signal. The augmented reality user device 200 authenticates the user 106 based on the user's input and allows the user 106 to generate and send property tokens 110. The augmented reality user device 200 identifies the user 106 and a user identifier 108 for the user 106 upon authenticating the user 106.

Once the user 106 is authenticated, the augmented reality user device 200 identifies the location of the user 106. In one embodiment, the augmented reality user device 200 identifies the location of the user 106 based on the geographic location of the user 106. For example, the augmented reality user device 200 uses geographic location information provided by a GPS sensor with a map database (e.g. a third-party database 118) to determine the location of the user 106 and to identify the property 150 at that location. In another embodiment, the augmented reality user device 200 uses object recognition and/or optical character recognition to identify the property 150. For example, the augmented reality user device 200 identifies the property 150 based on structures, street signs, house numbers, building numbers, or any other objects. In other embodiments, the augmented reality user device 200 identifies the location of the user 106 and the property 150 using any other suitable information. The augmented reality user device 200 generates or determines a location identifier 112 that identifies the location of the property 150.

In one embodiment, the augmented reality user device 200 obtains user history data 229 for the user 106. For example, the user history data 229 comprises a history of places (e.g. work and home) and businesses the user 106 recently visited. As another example, the user history data 229 comprises transaction history that identifies places the user 106 has recently shopped or made a purchase.

The augmented reality user device 200 generates a property token 110 and sends the property token 110 to the remote server 102. In one embodiment, the augmented reality user device 200 generates a property token 110 comprising the user identifier 108, the user history data for the user 106, and the location identifier 112. In other embodiments, the augmented reality user device 200 generates a property token 110 comprising any other suitable information or combinations of information. The augmented reality user device 200 encrypts and/or encodes the property token 110 prior to sending the property token 110 to the remote server 102.

The server 102 receives the property token 110 and processes the property token 110 to identify the user identifier 108, the location identifier 112, and the user history data. The server 102 decrypts or decodes the property token 110 when the property token 110 is encrypted or encoded by the augmented reality user device 200. The server 102 uses the user identifier 108 to look-up account information and/or accounts for the user 106 in the account information database 124. In one embodiment, the server 102 is configured to use the user identifier 108 to identify one or more accounts and/or transaction history for the user 106.

The server 102 identifies and aggregates neighborhood information about the area surrounding the property 150. For example, the neighborhood information may comprise information identifying amenities that are near the location of the user 106 and the property 150 using the location identifier 112. Examples of amenities include, but are not limited to, schools, stores, restaurants, hospitals, golf courses, banks, gyms, gas stations, police stations, fire stations, and airports. In some embodiments, the neighborhood information comprises crime information, demographic information, or any other information about the area surrounding the property 150.

The server 102 identifies places of interest for the user 106 based on the account information, the user history data, or any other information for the user 106. For example, the user history data comprises location history for the user 106. The server 102 uses the location history to determine where the user 106 works based on the time of the day the user 106 visits a particular location and the amount of time spent at the location. In this example, the workplace of the user 106 is a place of interest for the user 106. As another example, the user history data comprises transaction history. The server 102 uses the transaction history to determine places the user 106 has recently made a purchase. In this example, the identified places are likely places the user 106 prefers to shop and are places of interest for the user 106. In other examples, the server 102 uses any other information for determining places of interest for the user 106.

When the server 102 identifies a place of interest for the user 106, the server 102 determines or computes a commute time that indicates the travel time between the property 150 and the identified place of interest. For example, the server 102 determines the commute time between the property 150 and where the user 106 work using a map database (e.g. a third-party database 118). For instance, the server 102 provides the location of the property 150 and the location of where the user 106 works to the map database and receives the commute time in response. In other examples, the server 102 determines commute times between the property 150 and other places of interest for the user 106 using any other suitable technique as would be appreciated by one of ordinary skill in the art.

The server 102 generates virtual assessment data 111 that comprises the aggregated information for the user 106. The virtual assessment data 111 comprises neighborhood information, places of interest information, commute information identifying commute times, any other information, or combinations of information. The server 102 sends the virtual assessment data 111 to the augmented reality user device 200.

The augmented reality user device 200 receives the virtual assessment data 111 and processes the virtual assessment data 111 to access the information provided by the server 102. In one embodiment, the virtual assessment data 111 comprises neighborhood information and commute information. The augmented reality user device 200 generates a map based on the neighborhood information and the commute information. The augmented reality user device 200 generates a two-dimensional or a three-dimensional map that overlays the neighborhood information and the commute information onto the map. For example, the augmented reality user device 200 overlays nearby amenities, reported crime information, places of interest for the user 106, other comparable properties, and/or any other information onto the map. The augmented reality user device 200 may also overlay other related information such as traffic patterns and commute times to the places of interest.

The augmented reality user device 200 presents the generated map as a virtual object overlaid with tangible objects in real scene in front of the user 106. In other embodiments, the augmented reality user device 200 presents any other information as virtual objects overlaid with tangible objects in the real scene in front of the user 106. An example of the augmented reality user device 200 presenting a generated map to the user 106 as a virtual object overlaid with tangible objects in a real scene in front of the user 106 is described in FIG. 6.

FIG. 6 is another embodiment of a first person view from a display 208 of an augmented reality user device 200 overlaying virtual objects 302 with tangible objects 304 within a real scene 300. In FIG. 6, the user 106 is visiting a property 150 and is interested in aggregating information about the area around the property 150. The augmented reality user device 200 generates a location identifier 112 identifying the location of the user 106 and the property 150.

The augmented reality user device 200 generates a property token 110 comprising a user identifier 108 identifying the user 106, user history data for the user 106, and the location identifier 112 identifying the property 150. The augmented reality user device 200 sends the property token 110 to the remote server 102 to request information for the user 106 about the area surrounding the property 150.

The information about the area surrounding the property 150 may be determined based on information from multiple sources (e.g. the remote server 102 and/or third-party databases 118). Property tokens 110 allow the augmented reality user device 200 to request information regardless of the number of sources used to compile the requested information.

In response to sending the property token 110, the augmented reality user device 200 receives virtual assessment data 111 from the remote server 102. In one embodiment, the virtual assessment data 111 comprises neighborhood information, places of interest information, and commute information. In FIG. 6, the neighborhood information includes information about amenities that are nearby the property 150.

The augmented reality user device 200 generates map 602 based on the neighborhood information, the places of interest information, and the commute information. For example, the neighborhood information identifies a nearby hospital, lake, and airport. The augmented reality user device 200 uses virtual objects 302 to overlay the neighborhood information onto the map 602. The augmented reality user device 200 uses a virtual object 604 to indicate the location of the hospital, a virtual object 606 to indicate the location of the lake, and a virtual object 608 to indicate the location of the airport. In this example, the neighborhood information comprises crime information. The augmented reality user device 200 overlays virtual objects 610 onto the map 602 to indicate the locations of reported crime incidents.

The augmented reality user device 200 overlays the places of interests identified by the virtual assessment data 111 (i.e. the places of interest information) onto the map 602. For example, the augmented reality user device 200 overlays virtual object 612 onto the map 602 to indicate the location of a store the user 106 has previously made a purchase at according to the user's transaction history. The augmented reality user device 200 overlays virtual object 614 onto the map 602 to indicate the location of a restaurant the user 106 has recently eaten at according to the user's transaction history. The augmented reality user device 200 overlays virtual object 616 onto the map 602 to indicate the location of a school the user 106 has recently visited according to the user's geographic location history. The augmented reality user device 200 overlays virtual object 618 onto the map 602 to indicate the location of the property 150 the user 106 is looking at. The augmented reality user device 200 overlays virtual object 620 onto the map 602 to indicate the location of where the user 106 works. The augmented reality user device 200 overlays virtual object 622 onto the map 602 to indicate other comparable properties that are similar to the property 150 the user 106 is looking at. In other examples, the augmented reality user device 200 overlays virtual objects for any other types of places of interest for the user 106 onto the map 602.

The augmented reality user device 200 overlays the commute information onto the map 602. For example, the augmented reality user device 200 overlays virtual object 624 onto the map 602 indicating a route between the property 150 the user 106 is looking at and the location where the user 106 works. The augmented reality user device 200 overlays virtual object 626 onto the map 602 to indicate the commute time associated with the route. In other examples, the augmented reality user device 200 overlays virtual objects to indicate any other routes between the property 150 and other places of interest and associated commute times. In other embodiments, the augmented reality user device 200 overlays any other type of information or combinations of information onto the map 602, for example, traffic patterns.

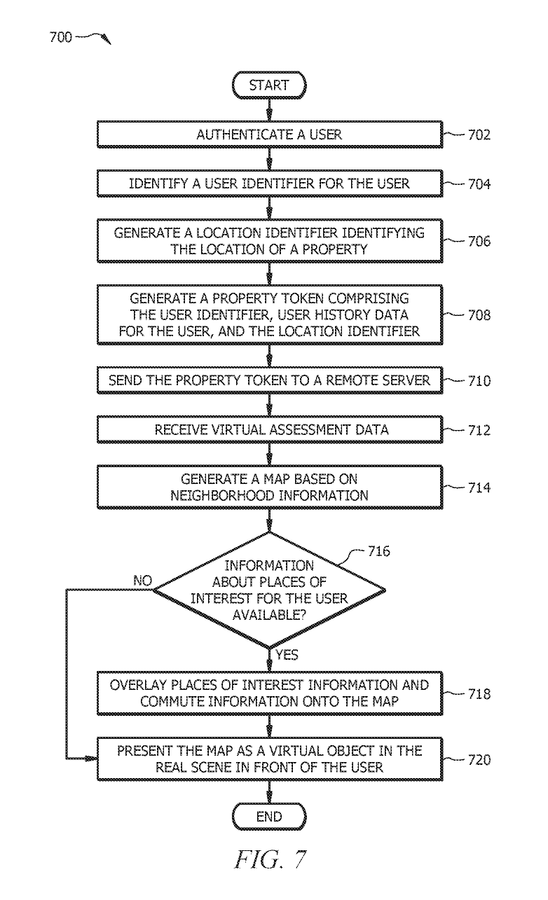

FIG. 7 is a flowchart of another embodiment of an augmented reality overlaying method 700 for an augmented reality user device 200. Method 700 is employed by the processor 202 of the augmented reality user device 200 to generate property tokens 110 based on the user 106 of the augmented reality user device 200 and the location of the user 106. The augmented reality user device 200 uses the property tokens 110 to request information about an area near a property 150 the user 106 is looking at. The augmented reality user device 200 uses the information to generate a map of the nearby area with information for the user 106 as a virtual object overlaid with tangible objects in a real scene in front of the user 106.

At step 702, the augmented reality user device 200 authenticates the user 106. The user 106 authenticates themselves by providing credentials (e.g. a log-in and password) or a biometric signal. The augmented reality user device 200 authenticates the user 106 based on the user's input. The user 106 is able to generate and send property tokens 110 using the augmented reality user device 200 upon authenticating the user 106.

At step 704, the augmented reality user device 200 identifies a user identifier 108 for the user 106. Once the user 106 has been authenticated, the augmented reality user device 200 identifies the user 106 and a user identifier 108 for the user 106. The user identifier 108 may be used to identify and authenticate the user 106 in other systems, for example, third-party databases 118.

At step 706, the augmented reality user device 200 generates a location identifier 112 identifying the location of a property 150. In one embodiment, the augmented reality user device 200 uses geographic location information provided by the GPS sensor 216 with a map database to determine the location of the user 106 and to property 150. In another embodiment, the augmented reality user device 200 uses object recognition and/or optical character recognition to identify the property 150 based on structures, street signs, house numbers, building numbers, or any other objects.

At step 708, the augmented reality user device 200 generates a property token 110. In one embodiment, the augmented reality user device 200 generates a property token 110 comprising the user identifier 108, user history data for the user 106, and the location identifier 112. In other embodiments, the augmented reality user device 200 generates a property token 110 comprising any other information. At step 710, the augmented reality user device 200 sends the property token 110 to a remote server 102.

At step 712, the augmented reality user device 200 receives virtual assessment data 111 from the remote server 102 in response to sending the property token 110 to the remote server 102. In one embodiment, the virtual assessment data 111 comprises neighborhood information identifying amenities proximate to the property 150, places of interest information identifying one or more places of interest for the user 106, and commute information identifying commute times from the property 150 to the one or more places of interest for the user 106. In other embodiments, the virtual assessment data 111 further comprises any other information about the property 150.

At step 714, the augmented reality user device 200 generates a map based on neighborhood information provided by the virtual assessment data 111. The augmented reality user device 200 generates a two-dimensional or a three-dimensional map that overlays the neighborhood information with a geographical map.

At step 716, the augmented reality user device 200 determines whether the virtual assessment data 111 comprises information about places of interest for the user 106. The augmented reality user device 200 proceeds to step 718 when the virtual assessment data 111 comprises information about places of interest for the user 106. Otherwise, the augmented reality user device 200 proceeds to step 720.

At step 718, the augmented reality user device 200 overlays the places of interest information and commute information onto the map. For example, the augmented reality user device 200 overlays virtual objects onto the map to indicate the location of a store the user 106 has previously made a purchase, the location of a restaurant the user 106 has recently eaten, the location of a school the user 106 has recently visited, the location of the property 150 the user 106 is looking at, the location of where the user 106 works, the locations of other comparable properties that are similar to the property 150 the user 106 is looking at or any other types of places of interest for the user 106. The augmented reality user device 200 overlays the commute information onto the map using virtual objects. For example, the augmented reality user device 200 overlays virtual object onto the map 602 indicating a route between the property 150 the user 106 is looking at and the location where the user 106 works. The augmented reality user device 200 overlays virtual object onto the map to indicate the commute time associated with the route.

At step 720, the augmented reality user device 200 presents the map as a virtual object in the real scene in front of the user 106.

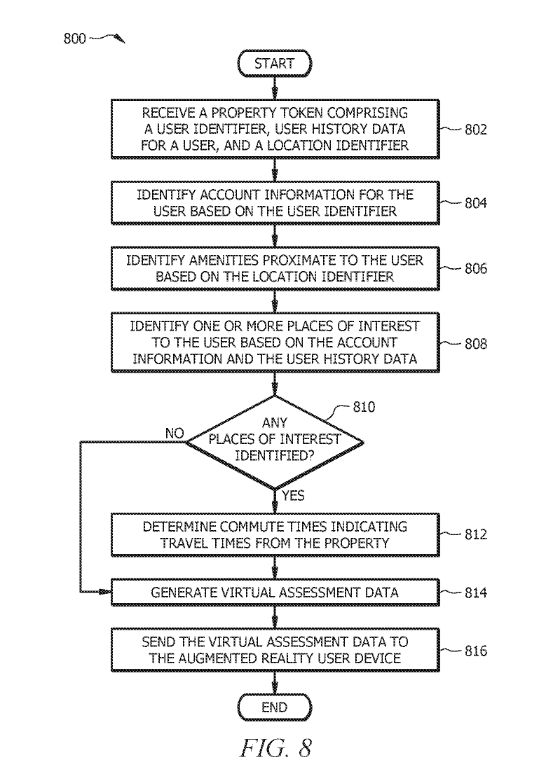

FIG. 8 is a flowchart of another embodiment of an augmented reality overlaying method 800 for a server 102. Method 800 is employed by the real estate compiler engine 122 in the server 102 to provide information about a property 150 and its surrounding area to a user 106 of the augmented reality user device 200 in response to receiving a property token 110 from the augmented reality user device 200.

At step 802, the real estate compiler engine 122 receives a property token 110 from the augmented reality user device 200. The real estate compiler engine 122 decrypts and/or decodes the property token 110 when the property token 110 is encrypted or encoded by the augmented reality user device 200. In one embodiment, the real estate compiler engine 122 processes the property token 110 to identify a user identifier 108, user history data for a user 106, and a location identifier 112. In other embodiments, the real estate compiler engine 122 processes the property token 110 to identify any other information.

At step 804, the real estate compiler engine 122 identifies account information for the user 106 based on the user identifier 108. For example, the real estate compiler engine 122 uses the user identifier 108 to look-up the account information and accounts for the user 106 in the account information database 124.

At step 806, the real estate compiler engine 122 identifies amenities proximate to the user 106 based on the location identifier 112. For example, the real estate compiler engine 122 uses the location identifier 112 with a map database (e.g. a third-party database 118) to look-up schools, stores, restaurants, hospitals, golf courses, banks, gyms, gas stations, police stations, fire stations, airports, and/or any other amenities that are near the property 150.

At step 808, the real estate compiler engine 122 identifies one or more places of interest for the user 106 based on the account information and/or the user history data 229. For example, the user history data 229 comprises location history for the user 106 and the real estate compiler engine 122 uses the location history to determine where the user 106 works based on the time of the day the user 106 visits a particular location and the amount of time spent at the location. As another example, the user history data 229 comprises transaction history and the real estate compiler engine 122 uses the transaction history to determine places the user 106 has recently made a purchase. In other examples, the server 102 uses any other information for determining places of interest for the user 106.

At step 810, the real estate compiler engine 122 determines whether any places of interest have been identified for the user 106. When the real estate compiler engine 122 identifies at least one place of interest for the user 106, the real estate compiler engine 122 proceeds to step 812. Otherwise, the real estate compiler engine 122 proceeds to step 814 when no places of interest have been identified for the user 106.

At step 812, the real estate compiler engine 122 determines commute times indicating travel times from the location of the user 106 (i.e. the property 150) to each of the identified places of interest. For example, the real estate compiler engine 122 determines the commute time between the property 150 and a place of interest using a map database (e.g. a third-party database 118). For instance, the server 102 provides the location of the property 150 and the location of place of interest to the map database and receives the commute time in response. In other examples, the real estate compiler engine 122 determines commute times between the property 150 and other places of interest for the user 106 using any other suitable technique as would be appreciated by one of ordinary skill in the art.

At step 814, the real estate compiler engine 122 generates virtual assessment data 111 comprising neighborhood information, places of interest information, commute information, and any other information for the user 106 about the property 150 or the area around the property 150. At step 816, the real estate compiler engine 122 sends the virtual assessment data 111 to the augmented reality user device 200.

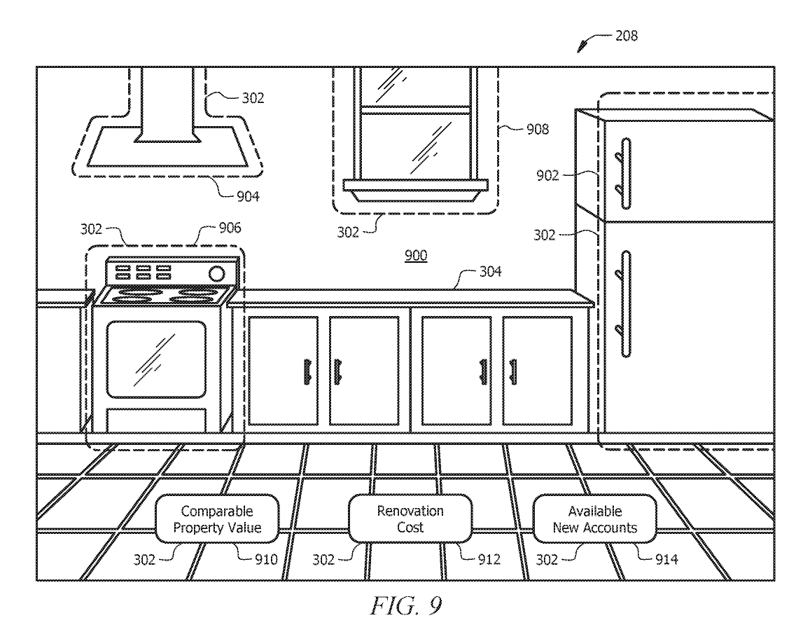

FIGS. 9-11 provide examples of how the augmented reality system 100 may operate when a user 106 wants to aggregate information for a renovation project for a real estate property 150. The following is another non-limiting example of how the augmented reality system 100 may operate when a user 106 is planning a renovation project for a real estate property 150. In this example, the user 106 is using the augmented reality user device 200 while looking at a portion of the property 150 that the user 106 would like to modify. For example, the user 106 may want to replace fixtures or appliance, remodel the property 150, repair damage to the property 150, perform new construction, or make any other kinds of modifications to features of the property 150. The user 106 authenticates themselves before using the augmented reality user device 200 by providing credentials (e.g. a log-in and password) and/or a biometric signal. The augmented reality user device 200 authenticates the user 106 based on the user's input and allows the user 106 to generate and send property tokens 110. The augmented reality user device 200 identifies the user 106 and a user identifier 108 for the user 106 upon authenticating the user 106.

Once the user 106 is authenticated, the augmented reality user device 200 identifies the location of the user 106. In one embodiment, the augmented reality user device 200 identifies the location of the user 106 based on the geographic location of the user 106. For example, the augmented reality user device 200 uses geographic location information provided by a GPS sensor with a map database (e.g. a third-party database 118) to determine the location of the user 106 and to identify the property 150. In another embodiment, the augmented reality user device 200 uses object recognition and/or optical character recognition to identify the property 150. In other embodiments, the augmented reality user device 200 identifies the location of the user 106 and the property 150 using any other suitable information. The augmented reality user device 200 generates or determines a location identifier 112 that identifies the location of the property 150.

While the user 106 is looking at the property 150, the augmented reality user device 200 captures images 207 of the property 150 and identifies different features of the property 150 based on the captured images 207. The augmented reality user device 200 may present a recommendation identifying alternative features for the identified features to the user 106. For example, the augmented reality user device 200 identifies the appliances that are currently in the property 150 and presents alternative appliances for the user 106. In one embodiment, the augmented reality user device 200 queries a third-party database 118 to request information about alternative features (e.g. appliances) for the identified features. The augmented reality user device 200 sends a message 113 identifying the features to a third-party database 118. The augmented reality user device 200 receives information about alternative features in response to sending the message 113 to the third-party database 118.

In one embodiment, the augmented reality user device 200 may present the alternative feature options to the user 106 using virtual objects overlaid with their corresponding features in the real scene in front of the user 106. The augmented reality user device 200 identifies selected alternative features indicated by the user 106. The augmented reality user device 200 receives the indication of the selected alternative features from the user 106 as a voice command, a gesture, an interaction with a button on the augmented reality user device 200, or in any other suitable form.

The augmented reality user device 200 generates a property profile 114 based on the identified features and the selected alternative features. The augmented reality user device 200 generates a property token 110 and sends the property token to the remote server 102. In one embodiment, the augmented reality user device 200 generates a property token 110 comprising the location identifier 112 and the property profile 114. In other embodiments, the augmented reality user device 200 generates a property token 110 comprising any other suitable information or combinations of information. The augmented reality user device 200 encrypts and/or encodes the property token 110 prior to sending the property token 110 to the remote server 102.

The server 102 receives the property token 110 and processes the property token 110 to identify the location identifier 112 and the property profile 114. The server 102 decrypts or decodes the property token 110 when the property token 110 is encrypted or encoded by the augmented reality user device 200. In one embodiment, the server 102 uses a user identifier 108 for the user 106 to look-up account information and/or accounts for the user 106 in the account information database 124 when the user identifier 108 is present in the property token 110.

The server 102 identifies a comparable property based on the location identifier 112 and the property profile 114. For example, the server 102 uses information provided by the property profile 114 to identify comparable properties with similar features as the alternative features and in a similar neighborhood. The server 102 identifies comparable properties using any information or technique as would be appreciated by one of ordinary skill in the art. In one embodiment, the server 102 uses information from the property profile 114 to identify comparable properties in the real estate information database 128. In another embodiment, the server 102 sends a data request 127 with information from the property profile 114 to request information about comparable properties. The server 102 determines a comparable property value for the comparable properties. The comparable property value is price of a comparable property with similar features and/or in a similar neighborhood as the property 150 the user 106 is looking at. The comparable property value may obtained while aggregating information about comparable properties. For example, the comparable property value may be obtained from the real estate information database 128 and/or a third-party database 118.

In one embodiment, the server 102 determines a cost associated with features, alternative features, or damage to the property 150 indicated by the property profile 114. The server 102 accesses a third-party database 118 to determine the cost associated with a features or damage. In one embodiment, the server 102 sends a data request 127 identifying one or more features to the third-party database 118. For example, the data request 127 comprises descriptors for the features. In some embodiments, the server 102 calculates a total cost associated with identified features. For example, the server 102 calculates the sum of costs associated with features, alternative features, repairs, and/or damage to the property 150 to determine an estimated renovation cost.

The server 102 generates virtual assessment data 111 that comprises the comparable property value, estimated renovation costs, estimate renovation time, a return on invest (ROI) estimate, available new accounts, any other information, or combinations of information for the user 106. The server 102 sends the virtual assessment data 111 to the augmented reality user device 200.

The augmented reality user device 200 receives the virtual assessment data 111 and processes the virtual assessment data 111 to access the information provided by the server 102. In one embodiment, the augmented reality user device 200 presents the comparable property value as a virtual object overlaid with tangible objects in real scene in front of the user 106. In other embodiments, the augmented reality user device 200 presents any other information as virtual objects overlaid with tangible objects in the real scene in front of the user 106. By presenting the comparable property value to the user 106, the user 106 can quickly assess whether the proposed project meets their expectations. For example, the user 106 can determine whether the proposed project and modifications to the property 150 will likely increase the value of the property 150 when the comparable property value is greater than the current price of the property 150. An example of the augmented reality user device 200 presenting information to the user 106 as virtual objects overlaid with tangible objects in a real scene in front of the user 106 is described in FIG. 9.

FIG. 9 is another embodiment of a first person view from a display 208 of an augmented reality user device 200 overlaying virtual objects 302 with tangible objects 304 within a real scene 900. In FIG. 9, a user 106 is looking at a kitchen of a property 150. In other examples, the user 106 may be looking at any other interior or exterior portion of the property 150. The augmented reality user device 200 generates a location identifier 112 identifying the property 150.

In one embodiment, the user 106 is looking at various features of the kitchen. The augmented reality user device 200 identifies features of the kitchen such as appliances, flooring material, windows, and cabinets. The augmented reality user device 200 also suggests and present alternative features for the kitchen that correspond with the existing features of the kitchen. In one embodiment, the augmented reality user device 200 presents the alternative features as virtual objects 302 overlaid with their corresponding features in the real scene in front of the user 106. For example, the augmented reality user device 200 overlays a virtual object 902 for an alternative refrigerator with the existing refrigerator. The augmented reality user device 200 overlays a virtual object 904 for an alternative oven vent with the existing oven vent. The augmented reality user device 200 overlays a virtual object 906 for an alternative oven with the existing oven. The augmented reality user device 200 overlays a virtual object 908 for a new window with a wall of the kitchen.

The augmented reality user device 200 determines which alternative features the user 106 selects and generates a property profile 114 based on the identified features and the alternative features. The augmented reality user device 200 generates a property token 110 comprising the location identifier 112 and the property profile 114. The augmented reality user device 200 sends the property token 110 to the remote server 102 to request information for the user about the proposed renovation project for the property 150.

The information about the project may be determined based on information from multiple sources. For example, information may be stored in the remote server 102 and in one or more third-party databases 118. The information about the property 150 and the project may be located in any other source or combinations of sources.

In response to sending the property token 110, the augmented reality user device 200 receives virtual assessment data 111 from the remote server 102. In one embodiment, the virtual assessment data 111 comprises a comparable property value, an estimated renovation cost, and information about new accounts that are available for the user 106. In this example, the augmented reality user device 200 presents the comparable property value as a virtual object 910, an estimated renovation cost as a virtual object 912, and information about available new accounts for the user 106 as a virtual object 914. In other examples, the augmented reality user device 200 presents any other information to the user 106 as virtual objects 302 overlaid with tangible objects in the real scene in front of the user 106. The augmented reality user device 200 allows the user 106 to visual the end result of a project in the context of the real scene while also presenting the aggregated information for the project to the user 106.

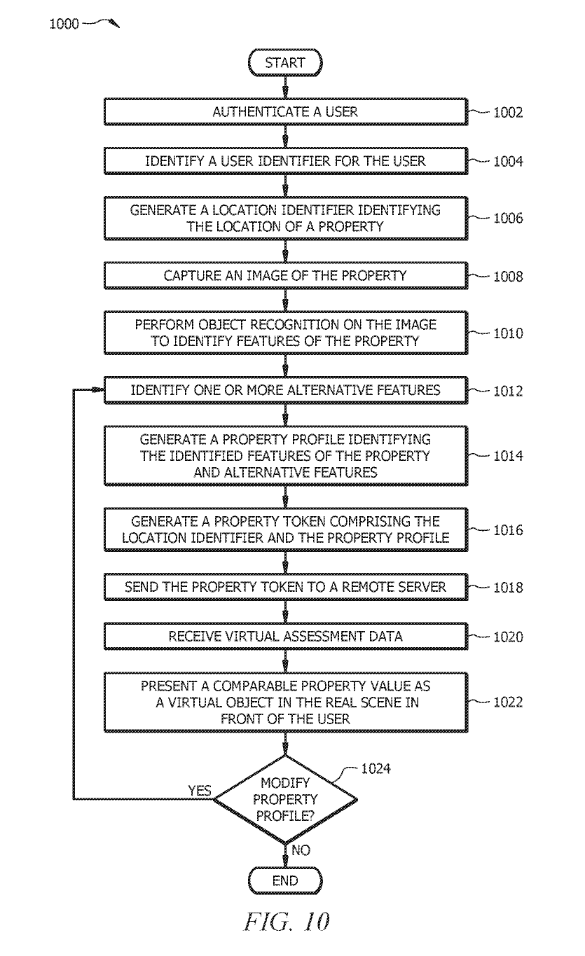

FIG. 10 is a flowchart of another embodiment of an augmented reality overlaying method 1000 for an augmented reality user device 200. Method 1000 is employed by the processor 202 of the augmented reality user device 200 to generate a property token 110 for requesting information for a project (e.g. a renovation project) for a property 150. The augmented reality user device 200 uses the token 110 to request information related to the project such as costs and the prices of properties with similar renovations. The augmented reality user device 200 overlays the received information as virtual objects overlaid with tangible objects in a real scene in front of the user 106.

At step 1002, the augmented reality user device 200 authenticates the user 106. The user 106 authenticates themselves by providing credentials (e.g. a log-in and password) or a biometric signal. The augmented reality user device 200 authenticates the user 106 based on the user's input. The user 106 is able to generate and send property tokens 110 using the augmented reality user device 200 upon authenticating the user 106.

At step 1004, the augmented reality user device 200 identifies a user identifier 108 for the user 106. Once the user 106 has been authenticated, the augmented reality user device 200 identifies the user 106 and a user identifier 108 for the user 106. The user identifier 108 may be used to identify and authenticate the user 106 in other systems, for example, third-party databases 118.

At step 1006, the augmented reality user device 200 generates a location identifier 112 identifying the location of the property 150. In one embodiment, the augmented reality user device 200 uses geographic location information provided by the GPS sensor 216 with a map database to determine the location of the user 106 and to property 150. In another embodiment, the augmented reality user device 200 uses object recognition and/or optical character recognition to identify the property 150 based on structures, street signs, house numbers, building numbers, or any other objects. In other embodiments, the augmented reality user device 200 uses a user input or any other information to generate a location identifier 112.

At step 1008, the augmented reality user device 200 captures an image 207 of the property 150. In one embodiment, the user 106 provides a command or signal to the augmented reality user device 200 that triggers the camera 206 to capture an image 207 of the property 150. In another embodiment, the augmented reality user device 200 and the camera 206 are configured to continuously or periodically capture images 207.

At step 1010, the augmented reality user device 200 performs object recognition on the image 207 to identify features of the property 150. For example, the augmented reality user device 200 identifies the features of the property 150 based on the size, shape, color, texture, material, and/or any other characteristics of the features. In other examples, the augmented reality user device 200 identifies features based on any other features of the products and/or using any other suitable technique.

At step 1012, the augmented reality user device 200 identifies one or more alternative features for the property 150. For example, the augmented reality user device 200 queries a third-party database 118 to request information about alternative features for the identified features. The augmented reality user device 200 sends a message 113 identifying the features to a third-party database 118 and receives information about alternative features in. In an embodiment, the augmented reality user device 200 receives an indication from the user 106 about which alternative features the user 106 wants to include in a property profile 114. At step 1014, the augmented reality user device 200 generates a property profile 114 identifying the identified features of the property 150 and the alternative features.

At step 1016, the augmented reality user device 200 generates a property token 110. In one embodiment, the augmented reality user device 200 generates a property token 110 comprising the location identifier 112 and the property profile 114. In other embodiments, the augmented reality user device 200 generates a property token 110 comprising any other information. At step 1018, the augmented reality user device 200 sends the property token 110 to a remote server 102.

At step 1020, the augmented reality user device 200 receives virtual assessment data 111 from the remote server 102. In one embodiment, the virtual assessment data 111 comprises a comparable property value. In other embodiments, the virtual assessment data 111 further comprises any other information about the property 150.

At step 1022, the augmented reality user device 200 presents a comparable property value to the user 106 as a virtual object overlaid with the real scene in front of the user 106. The augmented reality user device 200 presents the comparable property value and any other information provided by the virtual assessment data 111 as virtual objects overlaid with tangible objects in the real scene in front of the user 106.

At step 1024, the augmented reality user device 200 determines whether the user 106 wants to modify the property profile 114. For example, the user 106 may want to request another comparable property value using different features and/or other alternative features. The user 106 may indicate that they want to modify the property profile by providing a user input, for example, a voice command or gesture. When the augmented reality user device 200 determines that the user 160 wants to modify the property profile 114, the augmented reality user device 200 returns to step 1012. Otherwise, the augmented reality user device 200 may terminate method 1000 when the user 106 does not want to modify the property profile 114.

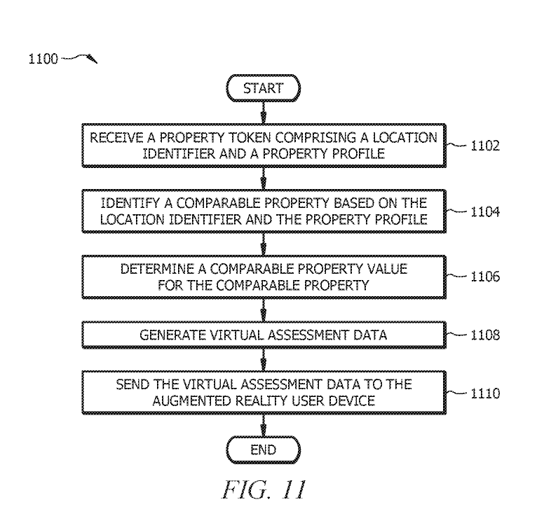

FIG. 11 is a flowchart of another embodiment of an augmented reality overlaying method 1100 for a server 102. Method 1100 is employed by the real estate compiler engine 122 in the server 102 to provide information related to a project for a property to a user 106 of the augmented reality user device 200 in response to receiving a property token 110 from the augmented reality user device 200.

At step 1102, the real estate compiler engine 122 receives a property token 110 from the augmented reality user device 200. The real estate compiler engine 122 decrypts and/or decodes the property token 110 when the property token 110 is encrypted or encoded by the augmented reality user device 200. In one embodiment, the real estate compiler engine 122 processes the property token 110 to identify a location identifier 112 and a property profile 114.

At step 1104, the real estate compiler engine 122 identifies a comparable property based on the location identifier 112 and the property profile 114. In one embodiment, the real estate compiler engine 122 uses information from the property profile 114 to identify comparable properties in the real estate information database 128. In another embodiment, the real estate compiler engine 122 sends a data request 127 with information from the property profile 114 to request information about comparable properties. At step 1106, the real estate compiler engine 122 determines a comparable property value for the comparable property.

At step 1108, the real estate compiler engine 122 generates virtual assessment data 111 comprising the comparable property value. At step 1110, the real estate compiler engine 122 sends the virtual assessment data 111 to the augmented reality user device 200.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An augmented reality system comprising:
an augmented reality user device for a user comprising:
a display configured to overlay virtual objects onto tangible objects in a real scene in real-time;
a camera configured to capture images of tangible objects;
a global position system (GPS) sensor configured to provide the geographic location of the user;
one or more processors operably coupled to the display, the camera, and the GPS sensor, and configured to implement:
an object recognition engine configured to identify tangible objects;
a virtual assessment engine configured to:
authenticate the user based on a user input;
identify a user identifier for the user in response to authenticating the user;
generate a location identifier identifying the location of a property based on the geographic location of the user;
capture an image of the property;
perform object recognition on the image to identify features of the property;
generate a property profile based on the identified features of the property;
generate a property token comprising:
the user identifier,
the location identifier, and
the property profile;
send the property token to a remote server;
receive virtual assessment data in response to sending the property token, wherein the virtual assessment data comprising:
historical property information for the property, and
a comparable property value; and
a virtual overlay engine configured to present the virtual assessment data as a virtual object overlaid with the real scene; and
the remote server comprising a real estate compiler engine configured to:
receive the property token;
identify account information for the user based on the user identifier;
identify the historical property information based on the location identifier;
identify a comparable property based on the property profile;
determine the comparable property value for the comparable property;
generate the virtual assessment data comprising the historical property information and the comparable property value; and
send the virtual assessment data to the augmented reality user device.

2. The system of claim 1, wherein:
the virtual assessment engine is configured to:
determine a listed property value for the property; and
adjust the listed property value based on the property profile to generate an adjusted property value; and
the virtual overlay engine is configured to present the adjusted property value.

3. The system of claim 1, wherein the historical property information comprises historical property sales information and tax information.

4. The system of claim 1, wherein:
the real estate compiler engine is configured to obtain public records for the property from a third-party database; and
the virtual assessment data comprises the public records.

5. The system of claim 1, wherein:
the real estate compiler engine is configured to obtain insurance claims information for the property from a third-party database; and
the virtual assessment data comprises the insurance claims information.

6. The system of claim 1, wherein:
the real estate compiler engine is configured to identify an available new account for the user based on the account information for the user; and
the virtual assessment data comprises information for the available new account for the user.

7. The system of claim 1, wherein:
the virtual assessment engine is configured to obtain neighborhood information identifying amenities proximate to the property based on the location identifier; and
the property profile comprises the neighborhood information.

8. An augmented reality overlaying method comprising:
authenticating, by a virtual assessment engine, a user based on a user input;
identifying, by the virtual assessment engine, a user identifier for the user in response to authenticating the user;
generating, by the virtual assessment engine, a location identifier identifying the location of a property based on the geographic location of the user;
capturing, by a camera operably coupled to the virtual assessment engine, the an image of the property;
performing, by the virtual assessment engine, object recognition on the image to identify features of the property;
generating, by the virtual assessment engine, a property profile based on the identified features of the property;
generating, by the virtual assessment engine, a property token comprising the user identifier, the location identifier, and the property profile;
sending, by the virtual assessment engine, the property token to a remote server;
identifying, by a real estate compiler engine of the remote server, account information for the user based on the user identifier;
identifying, by the real estate compiler engine, the historical property information based on the location identifier;
identifying, by the real estate compiler engine, a comparable property based on the property profile;
determining, by the real estate compiler engine, the comparable property value for the comparable property;
generating, by the real estate compiler engine, the virtual assessment data comprising historical property information and a comparable property value;
sending, by the real estate compiler engine, the virtual assessment data to the augmented reality user device; and
presenting, by a virtual overlay engine, the historical property information for the property and the comparable property value as virtual objects overlaid with the real scene.

9. The method of claim 8, further comprising:
determining, by the virtual assessment engine, a listed property value for the property;
adjusting, by the virtual assessment engine, the listed property value based on the property profile to generate an adjusted property value; and
presenting, by the virtual overlay engine, the adjusted property value.

10. The method of claim 8, wherein the historical property information comprises historical property sales information and tax information.

11. The method of claim 8, further comprising:
obtaining, by the real estate compiler engine, public records for the property from a third-party database; and
wherein the virtual assessment data comprises the public records.

12. The method of claim 8, further comprising:
obtaining, by the real estate compiler engine, insurance claims information for the property from a third-party database; and
wherein the virtual assessment data comprises the insurance claims information.

13. The method of claim 8, further comprising:
identifying, by the real estate compiler engine, an available new account for the user based on the account information for the user; and
wherein the virtual assessment data comprises information for the available new account for the user.

14. The method of claim 8, further comprising:
obtaining, by the virtual assessment engine, neighborhood information identifying amenities proximate to the property based on the location identifier; and
wherein the property profile comprises the neighborhood information.

15. An augmented reality device for a user comprising:
a display configured to overlay virtual objects onto tangible objects in a real scene in real-time;
a camera configured to capture images of tangible objects;
a global position system (GPS) sensor configured to provide the geographic location of the user;
one or more processors operably coupled to the display, the camera, and the GPS sensor, and configured to implement:
an object recognition engine configured to identify tangible objects;
a virtual assessment engine configured to:
authenticate the user based on a user input;
identify a user identifier for the user in response to authenticating the user;
generate a location identifier identifying the location of a property based on the geographic location of the user;
capture an image of the property;
perform object recognition on the image to identify features of the property;
generate a property profile based on the identified features of the property;
generate a property token comprising:
the user identifier,
the location identifier, and
the property profile;
send the property token to a remote server;
receive virtual assessment data in response to sending the property token, wherein the virtual assessment data comprising:
historical property information for the property, and
a comparable property value; and
a virtual overlay engine configured to present the virtual assessment data as a virtual object overlaid with the real scene.

16. The device of claim 15, wherein:
the virtual assessment engine is configured to:
determine a listed property value for the property; and
adjust the listed property value based on the property profile to generate an adjusted property value; and
the virtual overlay engine is configured to present the adjusted property value.

17. The device of claim 15, wherein the historical property information comprises historical property sales information and tax information.

18. The device of claim 15, wherein:
the virtual assessment engine is configured to obtain neighborhood information identifying amenities proximate to the property based on the location identifier; and
the property profile comprises the neighborhood information.

19. The device of claim 15, wherein the virtual assessment data comprises at least one of the public records and the insurance claims information.

20. The device of claim 15, wherein the virtual assessment data comprises information for the available new account for the user.
